(19) United States
(12) Patent Application Publication
(10) Pub. No.: US 2017/0189727 A1
(43) Pub. Date: Jul. 6, 2017

(54) SYSTEMS AND METHODS FOR REMOVING ULTRA-FINE PARTICLES FROM AIR

(71) Applicant: Free Air, Inc., Boone, NC (US)

(72) Inventors: Charles Eric Hunter, Boone, NC (US); Iyam Lynch, Boone, NC (US); Bradley G. Johnson, Boone, NC (US); J. Sid Clements, Boone, NC (US); Chengjie Li, Shenzhen City (CN); Dahua Xiao, Shenzhen City (CN); Matthew Ditrolio, West Bridgewater, MA (US)

(21) Appl. No.: 15/316,376

(22) PCT Filed: Jun. 4, 2015
(86) PCT No.: PCT/US2015/034260

§ 371 Date: Dec. 5, 2016

Related U.S. Application Data
(60) Provisional application No. 62/136,989, filed on Mar. 23, 2015.
(60) Provisional application No. 62/085,230, filed on Nov. 26, 2014.
(60) Provisional application No. 62/020,351, filed on Jul. 2, 2014.
(60) Provisional application No. 62/020,350, filed on Jul. 2, 2014.
(60) Provisional application No. 62/020,349, filed on Jul. 2, 2014.
(60) Provisional application No. 62/020,342, filed on Jul. 2, 2014.
(60) Provisional application No. 62/007,886, filed on Jun. 4, 2014.

(51) Int. Cl. A62B 7/10; A62B 23/02; A62B 18/08; A62B 9/00; A62B 18/02

(52) U.S. Cl. CPC A62B 7/10; A62B 9/00; A62B 18/02; A62B 18/08; A62B 23/02; F24F 3/16

(57) ABSTRACT

Implementations described and claimed herein provide systems and methods systems and methods for removing ultra-fine particles from air. In one implementation, a low power air purifying respirator is configured for filtering ultra-fine particles using a primary filter having a composite filter media, which may be pleated and may provide no outgassing. The respirator includes at least one fan providing positive pressure air flow to the primary filter at a low face velocity. The at least one fan may comprise a plurality of serially stacked, axial fans configured to increase air pressure without increasing flow. One or more safety valves are disposed along the air flow path to prevent back flow and carbon dioxide buildup during use. A user device may be in communication with a controller in the respirator to control the operations of the respirator. The respirator may be connected to a mask via a hose.

### CROSS-REFERENCE TO RELATED APPLICATION

The present application claims benefit under 35 U.S.C. §119 to: U.S. Provisional Patent Application No. 62/007,886, entitled “Low Power Respirator to Remove Ultrafine Particles” and filed on Jun. 4, 2014; U.S. Provisional Patent Application No. 62/020,350, entitled “Low Power Respirator with Low Face Velocity to Remove Ultrafine Particles” and filed on Jul. 2, 2014; U.S. Provisional Patent Application No. 62/085,230, entitled “Low Power Respirator with Low Face Velocity to Remove Ultrafine Particles” and filed on Nov. 26, 2014; U.S. Provisional Patent Application No. 62/136,986, entitled “Low Power Filtration System for Room Air Cleaner Use” and filed on Mar. 23, 2015; U.S. Provisional Patent Application No. 62/020,351, entitled “Low Power Respirator with Serial Fan Configuration to Remove Ultrafine Particles” and filed on Jul. 2, 2014; U.S. Provisional Patent Application No. 62/020,342, entitled “Low Power Respirator to Remove Ultrafine Particles and Controller System Therefor” and filed on Jul. 2, 2014; and U.S. Provisional Patent Application No. 62/020,349, entitled “Low Power Respirator to Remove Ultrafine Particles and Filter Media Therefor” and filed on Jul. 2, 2014 Each of these applications is incorporated by reference herein in its entirety.

### TECHNICAL FIELD

Aspects of the present disclosure relate to air purification and more particularly to low power, positive pressure powered air purifying respirator for removing ultra-fine particles.

### BACKGROUND

Air pollution is a serious and complex global problem. Long term exposure can lead to a variety of negative health consequences (e.g., loss of lung capacity, asthma, bronchitis, emphysema, and possibly some forms of cancer). Millions of deaths occur each year as a result of air pollution exposure. While air pollution is generally defined as airborne particles that are less than 10 microns in diameter (“PM10” class), the most dangerous class of airborne particulate pollution is the PM2.5 class, which includes pollutant particles that are less than 2.5 microns in diameter. Ultra-fine particles (“UFPs”) that are less than 0.1 microns (100 nm) pose serious health risks with the potential of enhanced toxicity and contribution to health effects beyond the respiratory system. Airborne diseases, such as bacterial or viral diseases, also present worldwide health issues. Such issues are especially concerning where a highly communicable, serious or life threatening disease emerges and spreads in a population, particularly if the disease is resistant to treatment or difficult to treat with existing therapies.

The general public often relies on passive dust or surgical masks for protection from pollution and disease. Such masks, however, only provide basic protection, are prone to leakage, and fail to filter the particularly hazardous UFPs. Moreover, the user of such masks often has to breathe considerably harder than normal due to the resistance imposed by the filter media. This extra exertion decreases comfort and prevents prolonged use. Many conventional masks are further prone to Carbon Dioxide and moisture buildup exacerbating these problems.

Conventional powered air purifying respirator (“PAPR”) devices are plagued by similar problems. Additionally, such PAPR devices are cumbersome, expensive, and generally only available for occupational applications. Notably, such PAPR devices are not suitable for protection against UFPs and are impractical for daily use.

It is with these observations in mind, among others, that various aspects of the present disclosure were conceived and developed.

### SUMMARY

Implementations described and claimed herein address the foregoing problems by providing systems and methods for producing purified air. In one implementation, a respirator for providing purified air into an enclosed space includes a housing having a top wall connected to a bottom wall with a pair of opposing side walls. At least one fan is configured to draw unfiltered air into the housing and generate a positive pressure air flow. A primary filter module is disposed within the housing, and the primary filter module includes at least one primary filter. The positive pressure air flow is provided to a surface of the primary filter at a low face velocity. The at least one primary filter removes ultra-fine particles from the positive pressure air flow and outputs the purified air. An outlet port through the housing receives the purified air from the primary filter module and directs the purified air to the enclosed space.

In another implementation, a primary filter module includes a sealed cartridge. An air inlet is defined in the cartridge and is configured to receive air. Two or more primary filters are bonded into the cartridge. Each of the primary filters comprises composite filter media configured to remove ultra-fine particles from the air received through the air inlet and provide purified air into a clean air space. An outlet port is disposed on the cartridge and is configured to receive the purified air from the clean air space and direct the purified air into an enclosed space.

In another implementation, a system for purifying air includes a housing having an interior. A plurality of serially stacked, axial fans is configured to draw air into the interior of the housing and generate a positive pressure air flow. A primary filter module is disposed within the interior of the housing and includes at least one primary filter for removing ultra-fine particles. The plurality of fans direct the positive pressure air flow through the at least one primary filter to provide purified air. An outlet port through the housing receives the purified air from the primary filter module and directing the purified air to an enclosed space at the positive pressure air flow.

In another implementation, an air filtration system for providing purified air into an enclosed space includes a respirator having at least one fan configured to draw unfiltered air into a housing and generate a positive pressure air flow through a primary filter module including at least one primary filter for removing ultra-fine particles from the unfiltered air to provide the purified air. A mask contains the enclosed space and is configured to receive the purified air from the respirator at the positive pressure air flow. A back flow valve is disposed along a path of the positive pressure air flow to prevent back flow.

In another implementation, a system for operating an air filtration system includes a housing having an outlet port configured to direct purified air into an enclosed space. At least one fan is configured to draw unfiltered air into the housing and generate a positive pressure air flow. A controller is in electrical communication with a power supply and configured to drive the at least one fan. A primary filter module is connected to the outlet port, and the primary filter module includes at least one primary filter for removing ultra-fine particles from the positive pressure air flow to provide the purified air to the outlet port. A user device is in communication with the controller and configured to obtain status feedback and to control an operation of the at least one fan.

In another implementation, a method for purifying air includes drawing air into a housing through an air intake. A positive pressure air flow for the air is generated using the at least one fan. The positive pressure air flow is directed to a surface of at least one primary filter. Purified air is produced by removing ultra-fine particles from the air using the at least one primary filter. The purified air is output into an enclosed space.

In another implementation, a method for controlling air filtration includes receiving input from a user device at a controller in electronic communication with at least one fan. The input includes a speed of the at least one fan. The at least one fan is driven at the speed to generate a positive pressure air flow directed at a surface of at least one primary filter configured for removing ultra-fine particles from the positive pressure air flow to produce purified air.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example air filtration system including a powered air purifying respirator fitted to a user during operation.

FIG. 2 shows an example air filtration system.

FIGS. 3A and 3B depict a side perspective view and a back view, respectively, of an example powered air purifying respirator.

FIG. 4 illustrates an interior view of the powered air purifying respirator.

FIG. 5 shows an air flow path through an example fan housing with a diffuser.

FIG. 6A shows an exploded view of an example filter module.

FIG. 6B depicts another exploded view of the filter module with the primary filters shown.

FIGS. 7A and 7B are front and side views, respectively, of air flow through the filter module.

FIGS. 8A and 8B illustrate the primary filters in a parallel orientation and an angled orientation, respectively.

FIGS. 9A-9C illustrate example filter configurations.

FIG. 10 shows example composite filter media.

FIGS. 11A-C depict example bonding of the composite filter media.

FIG. 12 shows an example pleated primary filter.

FIGS. 13A-C illustrate example particle detector configurations.

FIG. 14 shows an example hose having a tapered diameter.

FIG. 15 illustrates air flow paths through the respirator into a mask.

FIG. 16A shows an example hose and mask.

FIG. 16B is a detailed view of a distal end of the hose.

FIG. 16C is a detailed view of a pressure sensor in the distal end of the hose.

FIGS. 17A and 17B show a front perspective view and a back view, respectively, of an example mask.

FIG. 18A shows another example mask with a detailed cross sectional view of a proximal end of the hose connected to a receiver of the mask.

FIG. 18B shows a back perspective view of the mask and a detailed view of an example back flow valve.

FIG. 19 shows an example mask without a back flow valve.

FIGS. 20A and 20B illustrate a respirator with a back flow valve, shown in a closed and open orientation, respectively.

FIG. 21 shows an example mask connected to a hose via head straps.

FIG. 22 illustrates an example mask with a neck attachment.

FIG. 23 depicts a block diagram of example components of the respirator.

FIG. 24 shows an example controller.

FIGS. 25A-C show front, bottom, and side views, respectively, of an example user device.

FIGS. 26A and 26B illustrate a perspective view and a side cross sectional view, respectively, of an example carrying case for holding a respirator.

FIG. 27 illustrates example operations for purifying air.

FIG. 28 illustrates example operations for controlling air filtration.

FIG. 29 is an example computing system that may implement various systems and methods discussed herein.

### DETAILED DESCRIPTION

Aspects of the present disclosure generally relate to an air filtration system for removing ultra-fine particles (UFPs) to provide purified air into an enclosed space. In one aspect, the air filtration system includes a low powered air purifying respirator to filter UFPs at superior filter and power efficiencies by taking advantage of the dependence of the collection efficiency of the respirator on particle velocity at the surface of primary filter(s). The respirator includes at least one fan providing positive pressure air flow to the primary filter(s) at a low face velocity. The at least one fan may comprise a plurality of serially stacked, axial fans configured to increase air pressure without increasing flow. In addition to removing UFPs, the respirator provides protection against airborne pathogens.

In some aspects, the enclosed space includes a mask connected to the respirator with a hose. The positive pressure provided by the respirator prevents unfiltered air from leaking into the mask, for example, while the user inhales, as well as reduces the work of breathing while wearing the mask. Furthermore, the mask may include a one-way outlet valve to permit air to exit the mask at a predetermined pressure while preventing an inflow of unfiltered air into the mask. A back flow valve may additionally be disposed along the air flow path, for example, in the mask, to prevent carbon dioxide buildup during use. Purified air is thus safely provided to the enclosed space, with the power efficiency of the air filtration system permitting continuous, daily use.

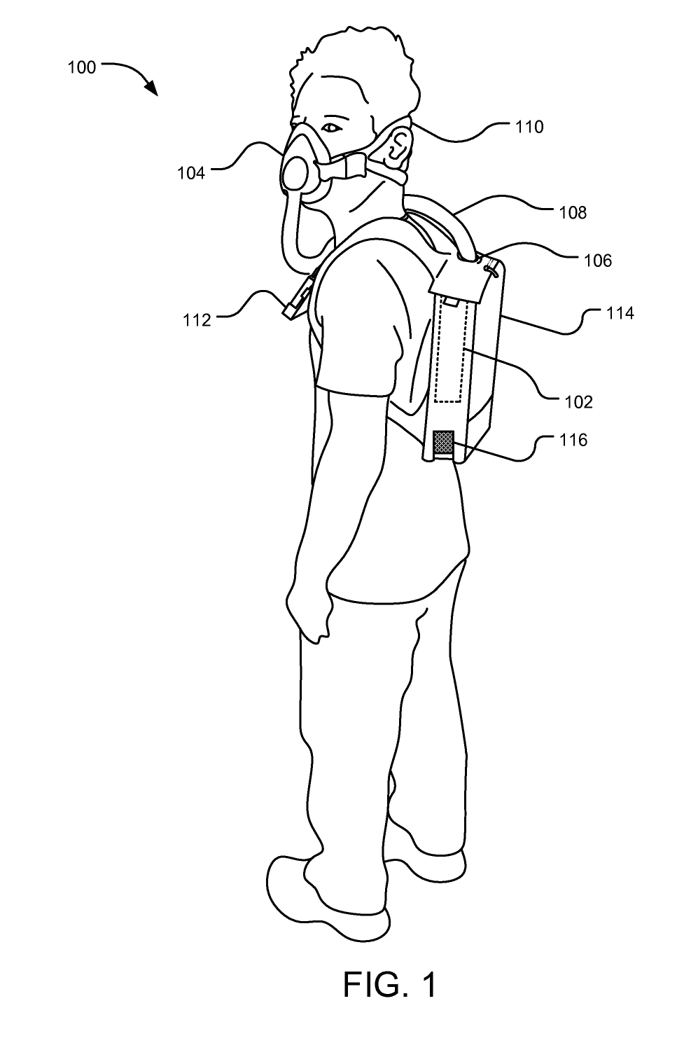

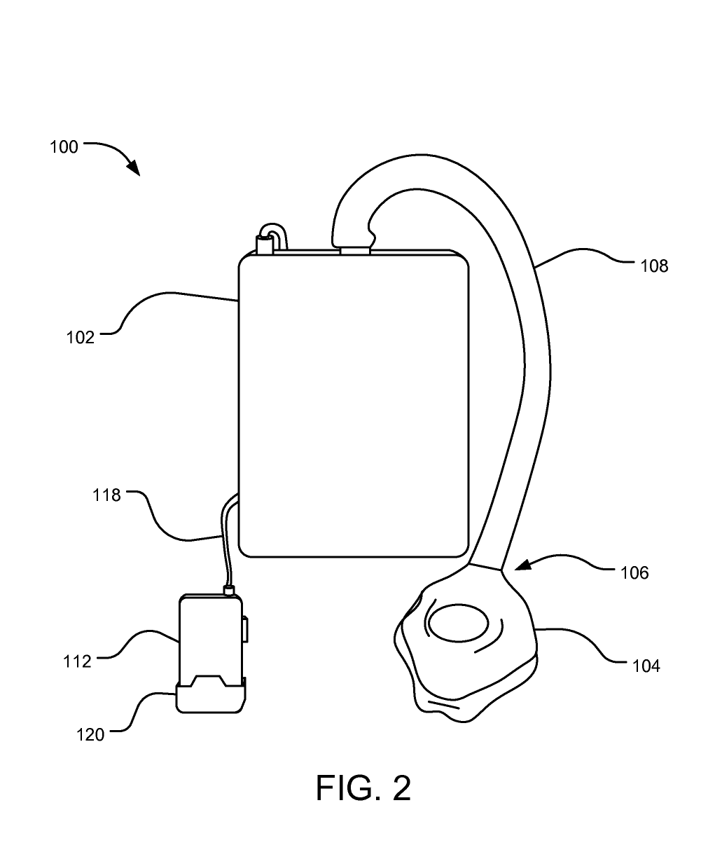

To begin a detailed description of an example air filtration system 100, reference is made to FIGS. 1-2. In one implementation, the air filtration system 100 includes a powered air purifying respirator 102 configured for removing UFPs to provide filtered air to an enclosed space, which may be, without limitation, a mask 104 fitted to a user with one or more straps 110. As described herein, the straps 110 may be provided in various orientations, including, without limitation, one or more head straps, a neck attachment along the jawline of a user, a helmet, and the like.

In one implementation, one or more hoses 108 connect the mask 104 to the respirator 102. The hose 108 may be detachable from the mask 104 and/or the respirator 102. In one implementation, the hose 108 tapers proximally from the respirator 102 to the mask 104, permitting a lower pressure drop through the air filtration system 100.

The tapering of the hose 108 may also permit the hose 108 to extend through a strap of a carrying case 114, which may be, without limitation, a messenger bag, a briefcase, a backpack, a purse, and other bags or cases configured for facilitating carrying of the respirator 102. A cover may wrap around the hose 108 prior to insertion into a strap of the carrying case 114. The cover may be formed, for example, from a spandex or similar material and include an attachment mechanism, such as paired hooks and loops.

The carrying case 114 may include various pockets, openings, access panels, and/or the like. For example, the carrying case 114 may include one or more vents 116 through which the respirator 102 draws in outside air for filtration. In one implementation, the carrying case 114 includes a pocket or similar attachment mechanism to hold a user device 112. In another implementation, the user device 112 includes a case 120 with an attachment mechanism, such as a clip, latch, fastener, clasp, pin, hook, or the like for attaching the user device 112 to the carrying case 114 or the user.

The user device 112 is in communication with the respirator 102 for controlling the operations of the respirator 102. The user device 112 is generally any form of computing device, such as a mobile device, tablet, personal computer, multimedia console, set top box, or the like, capable of interacting with the respirator 102. The user device 112 may communicate with the respirator 102 via a wired (e.g., Universal Serial Bus (USB) cable 118) and/or wireless (e.g., Bluetooth or WiFi) connection. In addition to controlling the operation of the respirator 102, the user device 112 may be used to monitor the performance of the respirator 102, including filter and collection efficiency, power consumption, system pressure, air flow rates, and the like. The user device 112 further provides real time information on power level, fan speed, filter life, and pressure alarm.

In one implementation, the respirator 102 achieves extremely high filter efficiencies below 10e⁻⁹ at low face velocities less than or equal to 5 cm/s. At such face velocities, the respirator 102 has a filter efficiency of 99.99999% down to 0.01 microns. The respirator 102 filters UFPs and (e.g., below 300 nm down to 10 nm and below), as well as pathogens of similar size. Conventional passive masks cannot achieve comparable filtration, due in part to the inhalation capacity of users. Smaller pore sizes in such passive masks would result in a large increase in the resistance a user would feel while attempting to draw air through the respirator 102 during inhalation. Such passive masks, thus, cannot achieve comparable filter efficiencies for particle sizes below 300 nm. As a result, conventional passive masks fail to filter UFPs below 100 nm, which may diffuse through the alveoli in the lung into the bloodstream and deposit in the brain or other vital organs causing or exacerbating diseases such as dementia, Alzheimer's, and the like, as well as fail to prevent the intrusion of pathogens such as dangerous flu viruses, the common cold, and other pathogens that are less than 100 nm in size.

The air filtration system 100 incorporates positive air flow, which provides increased comfort during normal breathing and protects against contamination resulting from leakage paths around the mask 108 caused by instantaneous negative pressure gradients due to inhalation or gasping. For example, the air filtration system 100 may deliver positive pressure air at flow rates of between approximately 50 and 300 standard liters per minute (“SLM”).

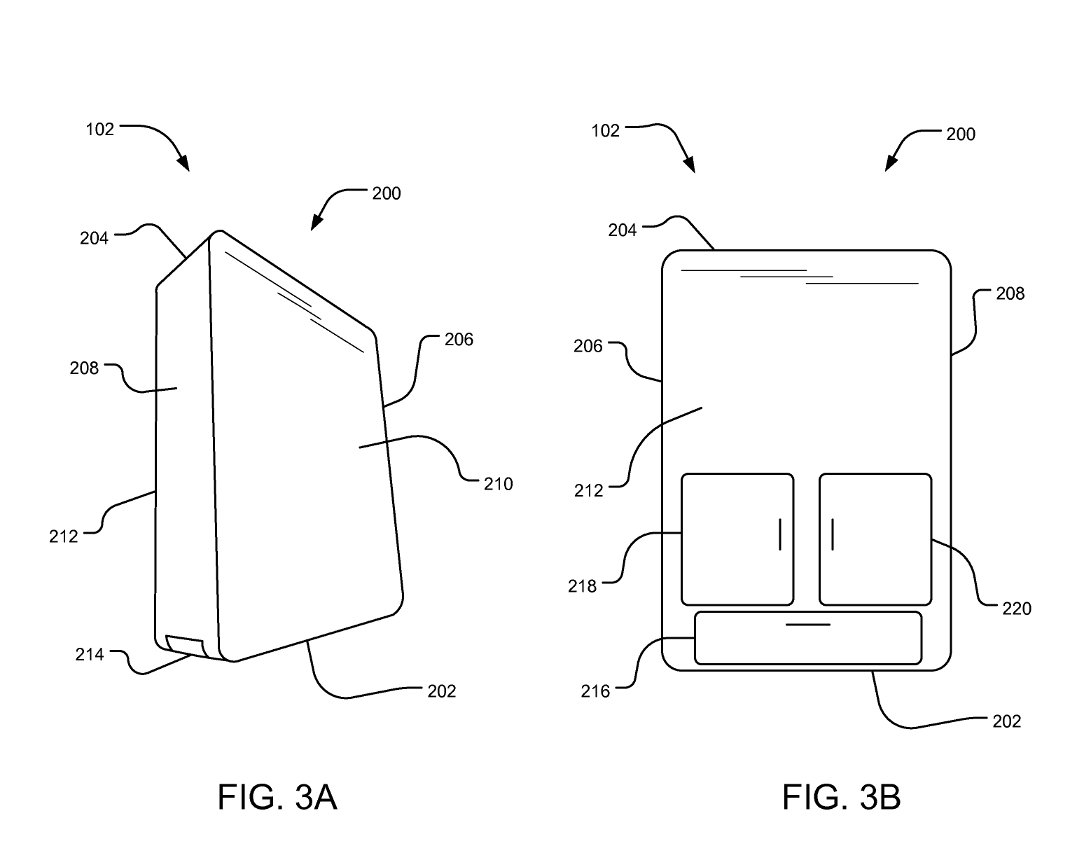

Turning to FIGS. 3A and 3B, a side perspective view and a back view of the respirator 102 is shown. In one implementation, the respirator 102 includes a housing 200 to enclose the internal components of the respirator 102. For instance, the housing 200 may comprise a chassis housing with top wall 204, bottom wall 202, side walls 206 and 208, and a back wall 212. In one implementation, a front wall 210 is a removable cover which, when attached or affixed to the chassis housing encases the internal components of the respirator 102.

In some implementations, one or more of the walls 202-212 may be configured with openings to provide access to internal components, provide for air flow into/out of the respirator 102, and/or the like. For example, the top wall 204 may include an opening or other type of access port to allow for access and replacement of internal components (e.g., a primary filter module) and to allow for air flow out of the respirator 102, as described herein. In one implementation, the bottom wall 202 includes an opening or other type of access port to allow for attachment/integration of an air entry mesh 214, and/or to allow for access and replacement of other internal components. The back wall 212 may include additional covers (e.g., covers 216-220) for accessing compartments holding internal components. For example, the cover 216 may be used to access a pre-filter, and the covers 218 and 220 may be used to access batteries. It will be appreciated, however, that more or fewer covers may be included for accessing a variety of different internal components.

Moreover, while the removable cover 210 illustrated in FIG. 3A extends the entire length of the chassis housing, the disclosure is not so limited. For instance, in certain implementations, the chassis housing may be enclosed by one or more cover portions that extend along portions of the chassis housing, for example, such that a first cover portion encloses a portion of the chassis housing comprising mechanical and electrical system components and a second cover portion encloses a portion of the chassis housing comprising the primary filter module.

The housing 200 may be a variety of shapes and sizes. For example, in one particular implementation, the overall dimensions of the housing 200 are approximately 260 mm×180 mm×56 mm. For example, the dimensions may be 260.35 mm×178.39 mm×55.56 mm or 265.11 mm×185.74 mm×56.36 mm. In another particular implementation, the overall dimensions of the housing 200 are approximately 190 mm×130 mm×50 mm. It will be appreciated that these dimensions are exemplary only and the housing 200 may be modified to accommodate larger or smaller dimensions. For example, by keeping the same proportions, the respirator 102 can function properly by being reduced by a percentage between 0 and 60% of these dimensions.

The housing 200 may be constructed from a light-weight, durable material. By way of non-limiting example, suitable materials for construction of the housing 200 include anodized aluminum, titanium, titanium alloys, aluminum alloys, fibrecore stainless steel, carbon fiber, Kevlar™, polycarbonate, polyurethane, or any combination of the mentioned materials.

In one implementation, air enters into the respirator 102 initially through the air entry mesh 214 attached or integrated at the bottom wall 202 of the housing 200. Although illustrated with the air entry mesh 214 disposed at the bottom of the housing 200, the disclosure is not so limited and alternative configuration and orientations are within the scope of the disclosure. For instance, the air entry mesh 214 may be configured on any of the other walls 204-212. In one implementation, the air entry mesh 214 is a separate component which is attached to the housing 200. In another implementation, the air entry mesh 214 is integrated into the housing 200 as a unitary component. The air entry mesh 214 may be constructed from a light-weight, durable material.

As described herein, the air entry mesh 214 provides initial protection against large particulates as well as offers a low resistance entrance for unfiltered air. As illustrated, the air entry mesh 214 may extend slightly up the side walls 206 and 208 anywhere from 0.5 inches to 2.0 inches to allow air to enter the respirator 102 even if it is placed on a surface that would block the majority of the holes of the air entry mesh 214 located on the bottom wall 202.

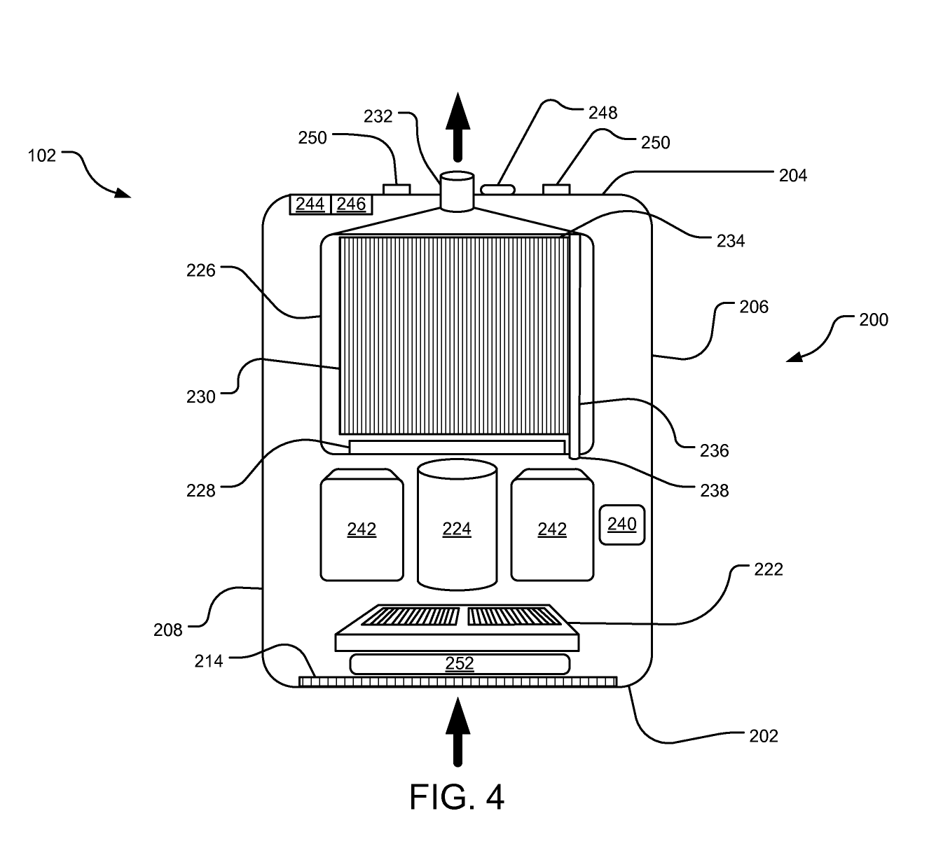

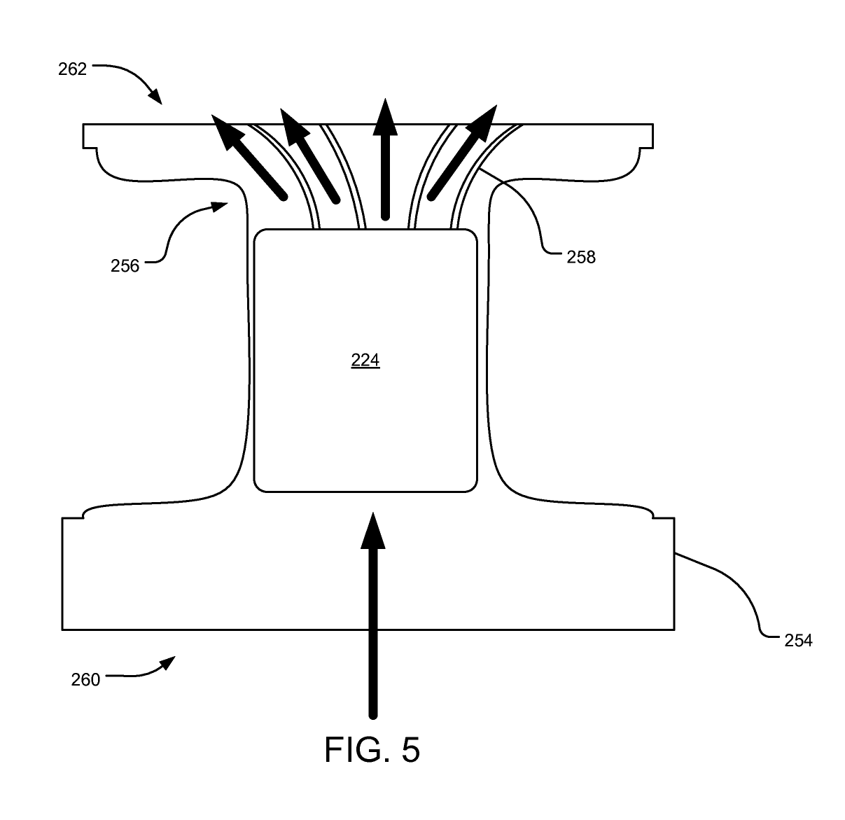

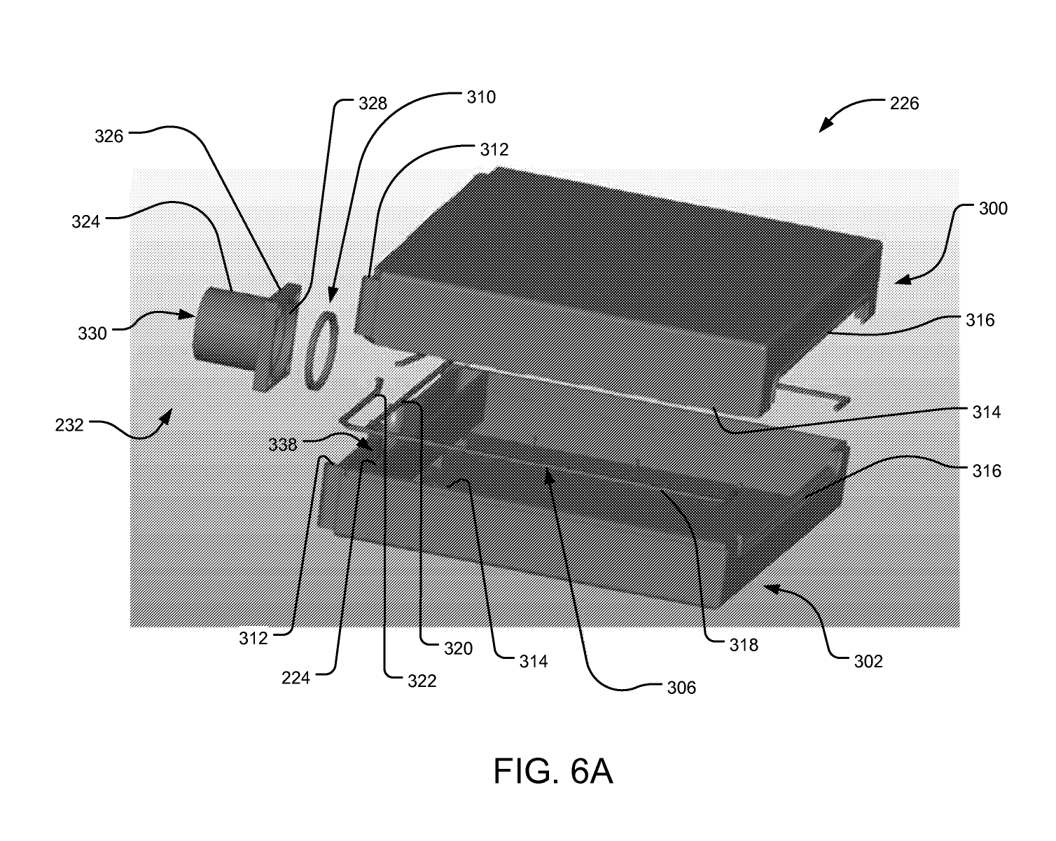

As can be understood from FIG. 4, in one implementation, the air entry mesh 214 serves as an initial entry port for non-filtered air to enter the respirator 104 and is therefore also the first region of large particle filtration. The openings of the air entry mesh 214 are sized and spaced such that each of the openings are large enough to reduce resistance to air being drawn into the respirator 102 and small enough to prevent very large particles from entering the respirator 102. In one implementation, the openings in the air entry mesh 214 are generally cylinders of a finite thickness and diameter arranged in parallel. The parallel arrangement of the openings allows for a linear reduction in flow resistance that is directly related to the number of openings without sacrificing the minimum opening dimension, which in turn governs the size of particles that are allowed to pass through the openings. In one particular implementation, the openings have a diameter of approximately 1.4 mm and a pitch between holes of approximately 2.4 mm. In another particular implementation, the openings have a diameter of approximately 1.5 mm and a pitch between holes of approximately 2.25 mm. It will be appreciated that these dimensions are exemplary only and the openings may include larger or smaller dimensions.

In one implementation, the air is pulled through the air entry mesh 214 into one or more fans 224. In another implementation, after entering the respirator 102 through the air entry mesh 214, the air is drawn through one or more pre-filters 222 using the fans 224. The pre-filter 222 filters large particles that could potentially build up on and/or damage the fans 224 and/or a primary filter module 226, which would decrease the lifetime of primary filters 230 within the filter module 226.

The pre-filter 222 may have any suitable filter pore size and may be formed in pleated or non-pleated configurations. For example, the pore sizes of the pre-filter 222 can range from approximately 0.1 micron-900 microns. Such pore sizes, and pleating/non-pleating configuration generally produce very low pressure drop.

The pre-filter 222 may be formed from a variety of suitable filter materials used in High-efficiency particulate arrestance (HEPA) class filters. For instance, the pre-filter 222 may be formed from Polytetrafluoroethylene (PTFE), Polyethylene terephthalate (PET), activated carbon, impregnated activated carbon, or any combination of the listed materials. These materials may also be, optionally, electrostatically charged. In one implementation, the pre-filter 222 is a single pleated or sheet of material. In another implementation, the pre-filter is co-pleated or laminated with other desired materials for combined benefits. By way of non-limited example, the pre-filter 222 may be configured as a 0.5 micron PET material co-pleated with activated carbon, potassium permanganate impregnated activated carbon material, and the like. In other implementations, the pre-filter 222 may include one or more hydrophobic layers, for example to minimize intrusion of moisture/water into the system. The hydrophobic layer(s) may be of generally large pore size (e.g., approximately 1 micron in diameter). By way of example, the PET material may provide filtration for particles 0.5 microns and up, the activated carbon may provide filtration of volatile organic compound (VOCs), smaller acid (SOx/NOx) gas molecules, and the like, as well as removal of odors/smells, and the hydrophobic layer may minimize intrusion of moisture/water.

The fans 224 are disposed near an air inlet 228 of the primary filter module 226. In one implementation, the fans 224 are disposed along the air path between the pre-filter 222 and the primary filter module 226. The fans 224 generate a positive pressure air flow that pulls air from outside through the air entry mesh 214 through the pre-filter 222 into the primary filter module 226 and out an air outlet port 232. In one implementation, the one or more fans 224 operate at high hydrostatic pressures (e.g., 3-5 inches of water) and generate high flow rates up to 300 SLM. In certain implementations, to achieve high efficiency for the primary filter module 226, the fans 224 operate between approximately 50 and 300 SLM. The fans 224 may operate at various speeds, for example, low (100 SLM), medium (130 SLM), and high (180 SLM). There may be sound proofing material around the fans 224. The material may be, without limitation, silicone.

In one implementation, the one or more fans 224 includes a plurality of fans in a series stacked, axial fan configuration (stack). Without intending to be limited by theory, as opposed to a parallel configuration (i.e., both fans disposed beside each other), the series (stacked) configuration allows the pressure output to be additive, whereas a parallel configuration results in an increase in overall flow. In one implementation, the fans 224 provide over a 70,000 hour runtime.

The static pressure of the respirator 102 may be increased by including a plurality of fans 224 in a stacked configuration having contra-rotating two stage axial impellers. In one implementation, two or more stacked fans 224 are provided, as described above, which rotate in opposite directions with the upstream fan having a pitch angle that is approximately 8-10 degrees higher than the fan further downstream.

In accordance with certain aspects of the disclosure, it is desirable to increase the overall pressure that is delivered by the fans 224 so that the air delivered in the air filtration system 100 has no trouble overcoming components in the respirator 102 (resistance objects) that result in pressure losses. Most conventional powered respirators known in the art use centrifugal fans that output at high pressures to address pressure loss. However, such centrifugal fans require a relatively large amount of power to operate. In contrast, the respirator 102 of the present disclosure utilizes a power efficient approach to obtain a more than sufficient pressure output from the fans 224 by connecting them in a series configuration. The fans 224 are highly energy efficient, and when multiple fans 224 are configured in series, a substantial pressure output is provided while maintaining efficient power delivery.

Any suitable fan design and configuration may be utilized in connection with present disclosure. For example, in addition to fan power and output, fan configurations may be selected based on fan blade size, shape, number, orientation, surface area, and the like. Pressure is proportional to the square of the rotations per minute (RPM). An increase in RPM will result in a power increase proportional to the cube of the RPM. Higher RPM means higher pressure, lower RPM means lower pressure, thereby requiring more blades. In one implementation, the number of fan blades is of less concern than total blade surface area. Blade surface area is the single blade's surface area times the number of blades.

Orientation may also be taken into consideration. For instance, if fan blades are too close together, there may not be sufficient air between the blades to have adequate performance. In one implementation, the fans 224 comprise fan blades that are narrow on the tip to decrease air resistance and will widen toward the hub. The angle of the fan blades may be minimized at the tip and generally increase toward the hub. In this regard, in one implementation, the transition from the angle at the tip to the angle at the hub may be gradual and/or smooth to prevent back flow.

The fans 224 direct the air into the primary filter module 226 through the air inlet 228. The primary filter module 226 may be configured to include one or more primary filters 230 and optional post-filter(s). In one implementation, the primary filters 230 are oriented parallel to the direction of air flow. In another implementation, the primary filters 230 are oriented at an angle relative to the direction of airflow. Other configurations and orientations are contemplated as well. In one implementation, the primary filter module 226 includes a pressure sensor intake port 238 and a pressure sensor intake 236 to measure the pressure within the primary filter module 226 during operation. The respirator 102 may further include a pressure sensor chip 248 configured to send pressure readings from outside the respirator 102 to be analyzed and recorded by a controller 240.

As described herein, the respirator 102 may include one or more pre-filters 222, primary filters 230, and post-filters. By way of non-limiting example, one or more optional charcoal post-filters, one or more optional charcoal pre-filters, and one or more primary filters 230, may be included. In certain aspects, the post-filters may be added to the system for increased protection, for example, from inhalation of VOCs, any outgassing that may occur from any of the filters 222 or 230 or glue used in the system, and the like. Any suitable filter material may be used as the pre-filters 222 and post-filter, including, by way of non-limiting example, activated carbon filter material that has been properly treated to prevent outgassing and fine particulate emission from the carbon filter itself. However, any suitable filter material may be used, and the disclosure is not limited to activated charcoal. Further, any suitable filter material may be used as the primary filter 230, including, but not limited to, a composite filter media.

For instance, by way of non-limiting example, the primary filters 230 may include any HEPA type membrane material, e.g., with a 0.1 micron-0.3 micron pore size made from an inert material such as PTFE, PET material, activated carbon, impregnated activated carbon, or any combination of the listed materials. These materials may also be, optionally, electrostatically charged. In one implementation, the primary filters 230 are a single pleated or sheet of material. In another implementation, the primary filters 230 are co-pleated or laminated with other desired materials for combined benefits. By way of non-limited example, the primary filters 230 may be a composite material including more than one layer of filter materials copleated using a thermal procedure (adhesiveless), or adhesive-based bonding to attach one or more additional layer(s) of filter material, load bearing material, activated carbon for added system protection, impregnated activated carbon, and/or the like. In one implementation, adhesive-based bonding is used, employing adhesives having low or no outgassing. Stated differently, the primary filters 230 may be formed by bonding, copleating, laminating or otherwise attaching additional layers to suitable filter materials.

In one particular implementation, the primary filter 230 includes an extra layer of Ultra-high-molecular-weight polyethylene (UHMWPE) added to the filter stack to increase the filter efficiency. The layers of the primary filter 230 may be affixed/bonded in any suitable manner, e.g., by thermal bonding, crimping, adhesive, etc. In certain implementations, the layers of the primary filter 230 may be bonded by crimping the edges and pleating together by loading into a collator. In other implementations, adhesive with a thickness range between approximately 0.5 oz per square yard to 3 oz per square yard, e.g., 1 oz per square yard may be used. Without intending to be limited by theory, the adhesive may add resistance to the primary filter 230, which may create and add pressure drop to the system. Thus, in one implementation, the UHMWPE membrane is formed as thin as possible. Alternatively, or in addition, any adhesive may be reduced or removed to decrease pressure drop and to reduce outgassing and VOCs emitted therefrom. If desired, activated carbon may also be added to remove VOCs (odors and chemical fumes).

In another particular implementation, the primary filter 230 includes a plurality of thermally attached layers, including a first PE/PET layer, an activated carbon layer, a first PTFE membrane layer, a second PE/PET layer, a second PTFE membrane layer, a third PE/PET layer, a second activated carbon layer, and a fourth PE/PET layer. The activated carbon layers remove VOCs.

In one implementation, the respirator 102 provides a particle velocity at the surface of the primary filters 230 (face velocity) less than or equal to 5 cm/s, 4 cm/s, 3 cm/s, 2 cm/s, or 1 cm/s. At such face velocities, the collection efficiency for the primary filters 230 in the respirator 102 is greater than 99.99%, 99.999%, 99.999%, 99.9999%, or 99.99999%, which greatly out performs conventional positive pressure respirators and filters. Further, using a face velocity of less than or equal to 5 cm/s, 4 cm/s, 3 cm/s, 2 cm/s, or 1 cm/s, also produces a lower pressure drop across the primary filters 230, as compared to using a higher face velocity, e.g., greater than 5 cm/s, which is beneficial for overall system efficiency (e.g., less demanding for the fans 224).

In one implementation, the respirator 102 has a filter efficiency of 99.99999% down to 0.01 microns. The respirator 102 utilizes composite filter media in combination with optimized flow rates, to provide highly cleaned air at a positive pressure to one or more users regardless of their pulmonary output or size. The respirator 102 can deliver positive pressure air at flow rates of up to and greater than 300 SLM (standard liters per minute), 100-300 SLM, 100-200 SLM, etc. This permits users with large lung volumes to utilize the respirator 102 at high exertion levels, making it a versatile platform that can be used in high pollution urban environments and in high particulate occupational areas.

The primary filters 230 were subjected to rigorous Virus filtration efficiency (VFE) tests to confirm the effectiveness of providing protection against viruses. In the study performed, the virus used to challenge the primary filters 230 was bacteriophage φX174 which is approximately 27 nm in size and was contained and delivered via aerosolized droplets. The average droplet size that contained the virus was approximately 3 micrometers and was delivered through the primary filter 230 at a face velocity over 3 times normal system operating parameter.

These test conditions were rigorous for the following reasons: (1) bacteriophage φX174 is a spherical particle that is neutral and affected by the electrostatic forces of the filter media which makes it easier to pass through the primary filter 230; and (2) the filtration efficiency of the primary filter 230 has an inverse relationship with face velocity (the higher the face velocity the lower the efficiency). Despite the extreme face velocity operating parameters, the filtration results for the primary filter 230 were exceptional. The average virus filtration efficiency for all filter media tested was 99.999991%, which far exceeds the HEPA standard of 99.97%. As an example, consider a room infected with 1 million virus particles. If a user was protected with the respirator 102 containing the primary filter 230, no virus particles (0.09) would pass through the primary filter 230 to infect the user. Conversely, in the same room using a conventional HEPA filter, 300 virus particles would pass through to infect the user.

As described herein, in addition to superior filtration efficiency, the respirator 102 achieves reduced power consumption. Generally, the functionality of a filter over time has a direct effect on the performance and efficiency of a power source 242. For instance, as a filter is loaded with particles the overall resistance of the filter is increased. When the filter resistance increases, it requires more energy output from the power source 242 to drive the fans 224 at the flow rate/face velocity set in the unloaded state. As such, in some implementations, the respirator includes the pre-filters 222 to extend the life of the primary filter 230 and reduce power consumption. The power source 242 may utilize, without limitation, direct current (DC), alternating current (AC), solar power, battery power, and/or the like. In one particular implementation, the power source 242 includes one or more lithium ion batteries that are rechargeable with a DC 15V power adapter. The batteries in this case each have a run time of approximately 12.87 hours at 100 SLM, 8.36 hours at 130 SLM, and 4.5 hours at 180 SLM.

In one implementation, the batteries of the power source 242 are hot swappable during operation of the respirator 102. For example, during use, if one or more of the batteries are low, the batteries may be can replaced individually without ever turning the respirator 102 off. Most powered devices will not operate once a battery is removed, and the battery from many powered devices can only be charged if it is disconnected from the device and placed on a separate docking station. The respirator 102 does not have this limitation, with the batteries being chargeable while the respirator 102 is in use.

In one implementation, the controller 240 manages the power consumption of the respirator 102 by controlling the charging and discharging of the one or more power sources 242. As described herein, the controller 240 receives a input from the user device 112 and/or controls on the respirator 102 and in response, activates the one or more fans 224 for providing airflow through the respirator 102 at various flow rates. In one implementation, the user device 112 communicates with the respirator 102 via a connection 246 (e.g., a wired connection or wireless connection). The controller 240 may also alter the speed of the fans 224 according to the charge level of the power sources 242 and may convert a provided input power through a power connector 244 to an appropriate charging voltage and current for the power sources 242. The controller 240 further manages other operations of the respirator 102. For example, the controller 240 may manage status light emitting diodes (LEDs) that indicate the current operational mode of the respirator 102, the operation of one or more particle detectors 252, the operation of one or more sensors, and the like. The LEDs may indicate when the primary filter 230 and/or other components need replacing. In one implementation, the primary filter module 226 may be removed for replacement through the top wall 204 using one or more snaps 250. More specifically, the primary filter module 226 is spring loaded into the respirator 102 and may be removed by pushing the snaps 250 in and slightly pushing down on the primary filter module 226 to pop the primary filter module 226 out the respirator 102. In one implementation, the power sources 242 and the controller 240 are disposed outside of the air flow path.

Referring to FIG. 5, in one implementation, the fans 224 are contained within a fan housing 254, which is disposed along the air flow path between the air entry mesh 214 and the primary filter module 226. The pre-filter 222 may be disposed between the air entry mesh 214 and the fan housing 254.

In one implementation, the fans 224 draw air though an intake 260 in the fan housing 254 and direct the air into the air inlet 228 of the primary filter module 226 from an outlet 262 in the fan housing 254. The air flow may be directed into the primary filter module 226 using a flow transitional diffuser 256 disposed downstream of the fans 224. The diffuser 256 includes one or more surfaces 258 that spread the airflow evenly across the primary filters 230, ensuring that particles collected by the primary filters 230 are not concentrated in any one region, thereby increasing the overall lifetime of the primary filters 230 and consequently the power sources 242.

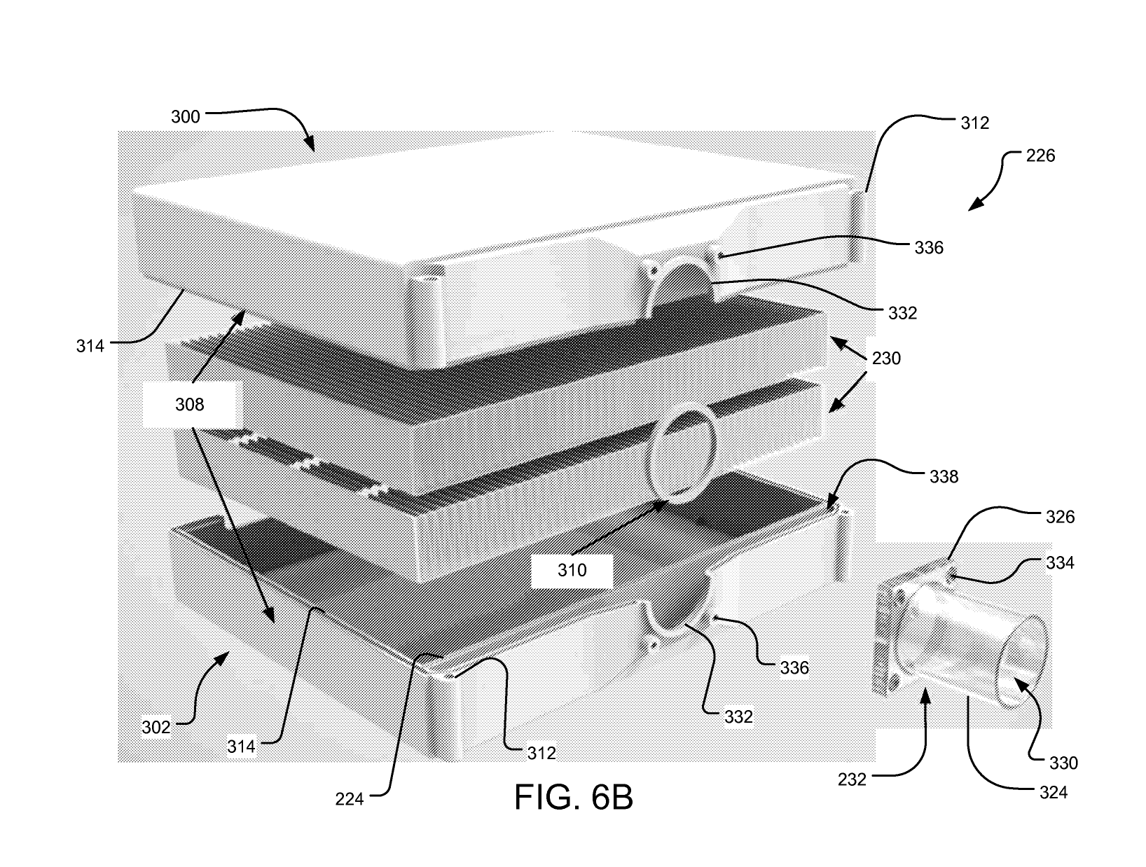

Turing to FIGS. 6A-6B, exploded views of the primary filter module 226 are shown. In one implementation, the primary filter module 226 is adequately sealed to allow contaminated air to be filtered properly. A first section 300 and a second section 302 may be connected to form a cartridge 308. In one implementation, the cartridge 308 is sealed using a gasket 306 and an O-ring 310. The gasket 306 may be made from a variety of materials, including, without limitation, silicone, or other rubbers.

In one implementation, the gasket 306 includes a pair of longitudinal bodies 318 extending along a length of edges 314 in a groove 224 of the second section 302. The longitudinal bodies 318 include perpendicular tips terminating at an opening 316 in the second section 302. The first section 300 includes a corresponding opening 316 that together with the opening 316 in the second section 302 forms the air inlet 228. The gasket 306 further includes a transverse body 320 connecting the longitudinal bodies and extending along a clean air section 338, as well as a pair of arms 322 extending along the grooves 224 and terminating in a cutout 332 in the second section 302. The first section 300 includes a corresponding cutout 332 to form an opening into the outlet port 232 that is sealed with the O-ring 310.

As such, the gasket 306 fits around an entirety of the edges 314 of the second section 302. After the gasket 306 is molded into the groove 224, in one implementation, the first section 300 is clamped onto the O-ring 310 over the gasket 306 and sealed to the second section 302 using ultrasonic welding. It will be appreciated that other sealing approaches may be used, including, but not limited to adhesives such as hot melt, epoxies, or urethanes in place of the gasket 306. In one implementation, the cartridge 308 includes screw posts 312 that serve as a backup mechanism to prevent catastrophic failure from unforeseen events such as expansion of the gasket 306 and/or glue cracking. While the integrity of the seal is important for the entire cartridge 308, the clean air section 338 is of particular focus because filtered air is contained within the clean air section 338 until it is directed though the outlet port 232 for use.

In one implementation, the outlet port 232 includes a tube 324 extending from a surface 326. The surface 326 includes an edge 328 defining an opening 330 extending through the tube 324 through which filtered air is directed into an enclosed space. In one particular implementation, the outlet port 232 has an inner diameter of approximately 22.4 mm, an outer diameter of approximately 23.6 mm, and a thickness of approximately 1 mm. In another particular implementation, the outlet port 232 has an inner diameter of approximately 21.5 mm, an outer diameter of approximately 24.6 mm, and a thickness of approximately 1.6 mm. However, it will be appreciated that these dimensions are exemplary only and the outlet port 232 may have larger or smaller dimensions.

As described herein, where the enclosed space is the mask 104, the tube 324 may connect to a distal end of the hose 108. The opening 330 may be sized to match the opening in the cartridge 308 formed by the cutouts 332 in the sections 300 and 302. In one implementation, the surface 326 includes one or more screw ports 334 corresponding to screw ports 336 on the cartridge 308 for attaching the outlet port 226.

As described herein, the primary filter module 226 may include one or more primary filters 230, which may be bonded or otherwise secured into the cartridge 308. The primary filters 230 may be bonded into the cartridge 308 using any suitable adhesive, such as medical grade adhesive that does not outgas, or has low outgassing, emissions and odors.

In the example shown in FIG. 6B, the primary filters 230 comprise two pleated filters in a parallel orientation. The primary filters 230 are edge banded with PET material that runs around the entire perimeter of the cartridge 308. The primary filter 230 are bonded into the cartridge 308 using, for example, adhesives such as hot melt, epoxies, or urethanes. The clean air section 338 is isolated (i.e., completely sealed away) from unfiltered air and disposed outside the primary filters 230 to allow filtered air flow to transition to the outlet port 232.

The primary filters 230 may have various orientations relative to each other inside the cartridge 308. For example, the primary filters 230 may be angled to reduce the size of the primary filter module 226. When the angle is equal to 0 degrees, the primary filters 230 are perfectly parallel. Conversely, when the angle is equal to 90 degrees the primary filters 230 are perfectly perpendicular. As the angle increases, the loading of the primary filters 230 becomes increasingly unevenly distributed along the primary filters 230. By way of example, an angle of 60 degrees allows for minimization of the effects of uneven loading of the primary filters 230 during use yet provides for size reduction.

In one implementation, the primary filters 230 are pleated to increase the surface area and edge banded with material such as PET or PE (polyethylene or polyester) to allow for bonding and sealing the primary filter 230 to the cartridge 226. By way of example, the size of the primary filter 230 may range between 1.38 square feet to 4.13 square feet for maximum flow rates (i.e., flow rate for highest setting) between, for example, 100 SLM-200 SLM. The size of the filter may be determined based on face velocity and volumetric flow rate of the air store entering the primary filter module 226. In one particular implementation, for a pollution application, a desired airflow face velocity may be selected to not exceed 1.3 cm/s.

The following equation provides the filter face velocity as a function of filter surface area:

v=QAₛ

In this equation, v is the filter face velocity, Q is the volumetric flow rate of the air stream entering the filter, and As is the surface area of the filter.

As discussed herein, in some implementations, the respirator 102 keeps the particle velocity at the surface of the primary filter 230 (i.e., face velocity) less than or equal to 5 cm/s, 4 cm/s, 3 cm/s, 2 cm/s, or 1 cm/s. This low face velocity may be achieved, at least in part, by increasing the surface area of the primary filters 230, for example, by pleating the primary filters 230, using more than one primary filter 230, and/or the like.

In one implementation, the face velocity is directly proportional to the volumetric flow rate (Q) and inversely proportional to the surface area (As) of the filter as shown in the equation below:

$$ν = \frac{Q}{{A}_{s}}$$

The surface area (As) of the primary filter 230 may be greatly increased by pleating. The surface area of a pleated filter can be calculated using the following expression (for 1 filter):

$${A}_{s} = {2}^{*} {L}^{*} {W}^{*} {d}^{*} \frac{\# pleats}{inch}$$

In this equation, L is the length of the pleated filter, W is the width of the pleated filter, d is the pleat depth, and #pleats/inch represents the pleat density. The equation shows that the surface area is directly related to the number of pleats present on the surface, so increasing the amount of pleats allows for the increase in the overall surface area and a corresponding decrease in the face velocity.

In one implementation, when coupled in a parallel configuration with another primary filter 230 of the same dimensions, such a configuration will generally generate a face velocity of less than or equal to 1 cm/s under normal operating flow rates of 80-200 SLM. Such a face velocity and high performing filter material filters particles, including viruses, bacteria, cellular particles, dust, pollutants, and the like, as small as 30 nm picornaviruses and rhinoviruses.

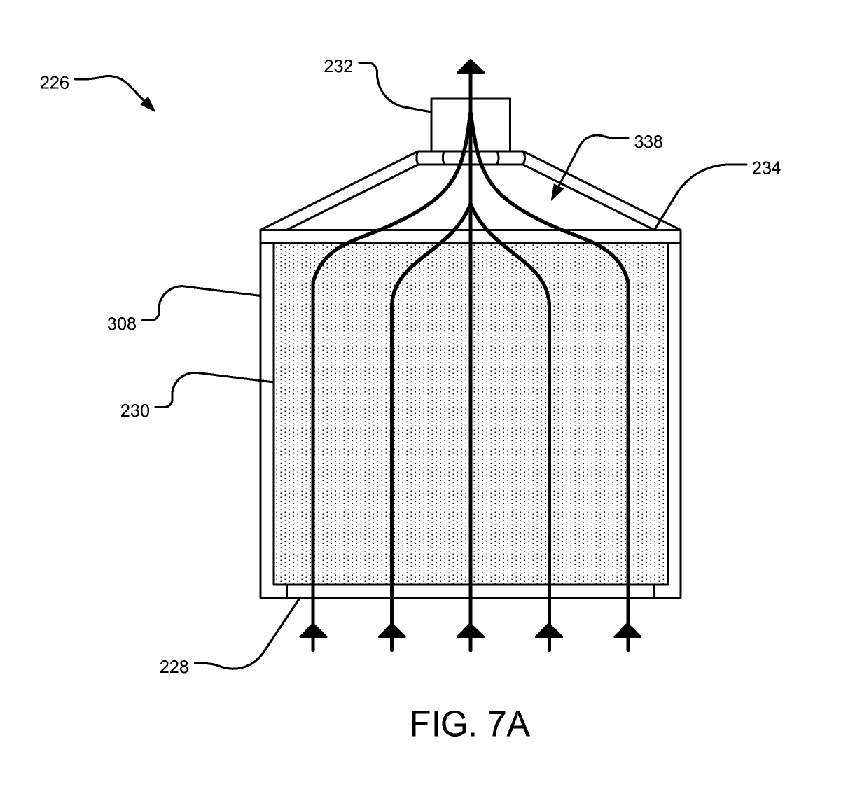

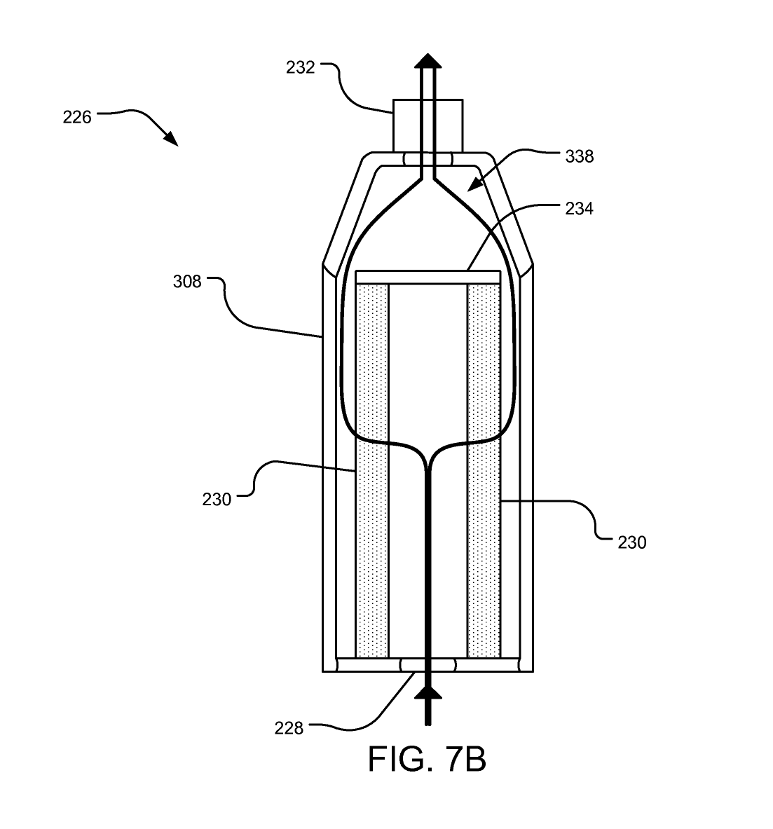

FIGS. 7A and 7B illustrate the air flow through the primary filter module 226. Upon entering primary filter module 226 through the air inlet 228, the air flow is directed along one or more paths through the primary filters 230 where the filtered air combines in the clean air section 338 before being output through the air outlet 232.

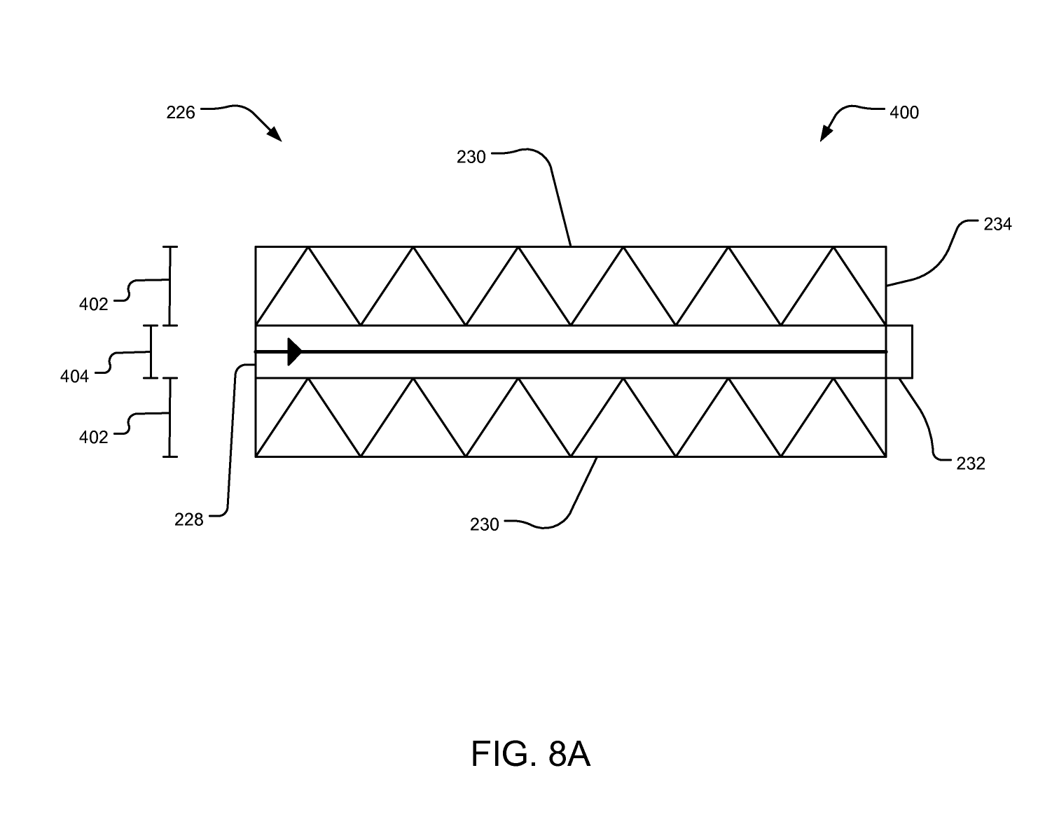

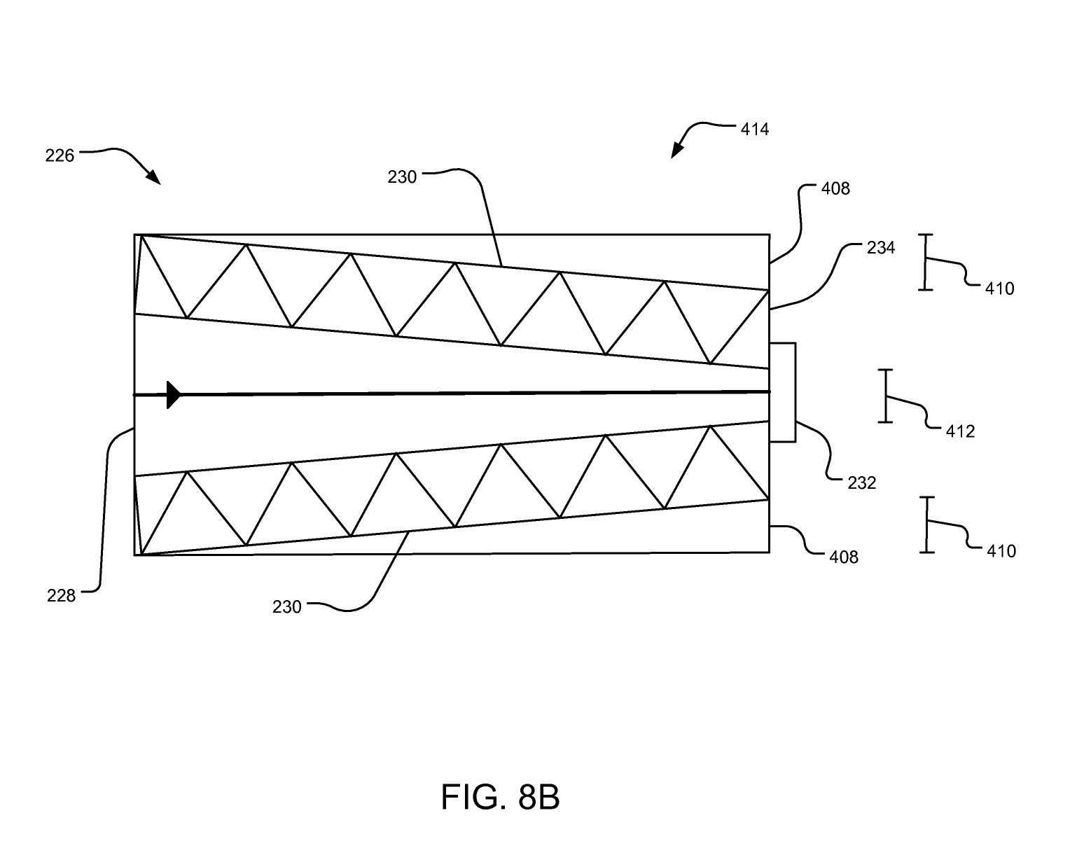

As described herein, the primary filters 230 may be oriented at various angles relative to the direction of air flow from the fans 224. For example, the primary filters 230 may be in a parallel orientation 400 relative to the direction of air flow, as shown in FIG. 8A. In one particular implementation, the primary filters 230 each have a diameter 402 of approximately 19 mm and are separated by a distance 404 of approximately 15 mm. As another example, the primary filters 230 may be in an angled orientation 414, as shown in FIG. 8B. In one particular implementation, the primary filters 230 are angled such that sidewalks 408 approximately 2-3 mm in size are created for outlet air to travel through and the distance between the primary filters 230 tapers towards the outlet port 232, where the primary filters 230 are separated by a distance 412 of approximately 11 mm. It will be appreciated that other orientations and dimensions are contemplated.

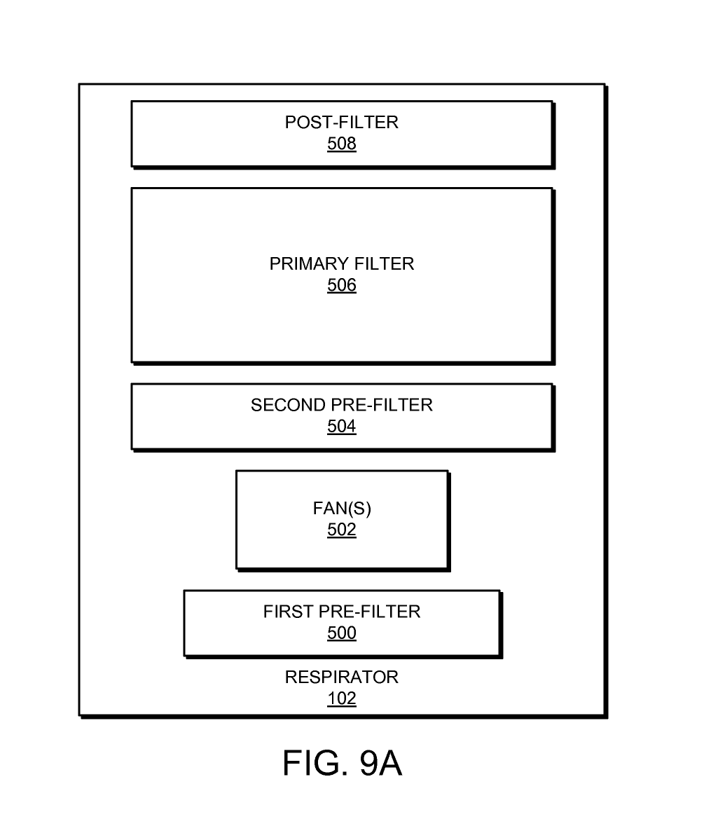

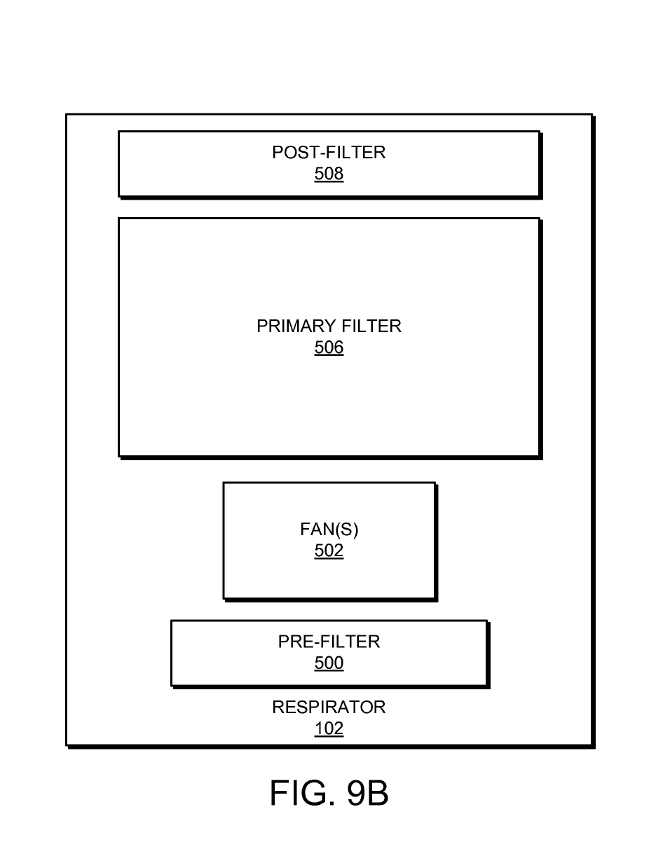

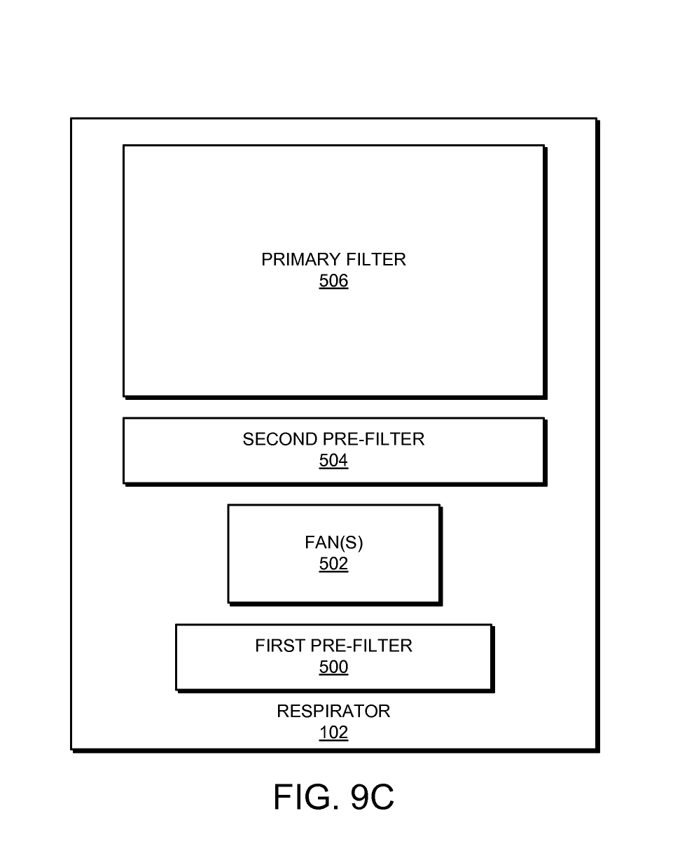

Turning to FIGS. 9A-9C, example filter configurations are illustrated. In some implementations, the respirator 102 includes one or more optional pre-filters and/or post filters in addition to one or more primary filters. Referring first to FIG. 9A, in one implementation, the respirator 102 includes one or more fans 502 disposed between a first pre-filter 500 and a second pre-filter 504. One or more primary filters 506 are disposed downstream from the second pre-filter 504, followed by a post-filter 508. Turning next to FIG. 9B, in another implementation, the respirator 102 includes the fans 502 disposed between the pre-filter 500 and the primary filter 506, which is followed by the post-filter 508. In yet another implementation shown in FIG. 9C, the respirator 102 includes the fans 502 disposed between the first pre-filter 500 and the second pre-filter 504 followed by the primary filter 506.

The post-filter 508 provides increased protection, for example, from inhalation of VOCs, any outgassing that may occur from any of the filters 500, 504, and/or 506 or adhesives used in the respirator 102, and/or the like Any suitable filter material may be used as the pre-filters 500 and 504 and the post-filter 508, including, without limitation, activated carbon filter material (charcoal) that has been properly treated to prevent outgassing and fine particulate emission from the carbon filter itself. Further, any suitable filter material may be used as the primary filter 506, including, but not limited to, a composite filter media, as described herein. In one implementation, the primary filter 506 may be formed from any HEPA type membrane material, for example, with a 0.1 micron-0.3 micron pore size made from an inert material such as PTFE, PET material, activated carbon, impregnated activated carbon, or any combination of the listed materials. These materials may also be, optionally, electrostatically charged. In one implementation, the primary filter 506 is a single pleated or sheet of material. In another implementation, the primary filter 506 is co-pleated or laminated with other desired materials for combined benefits.

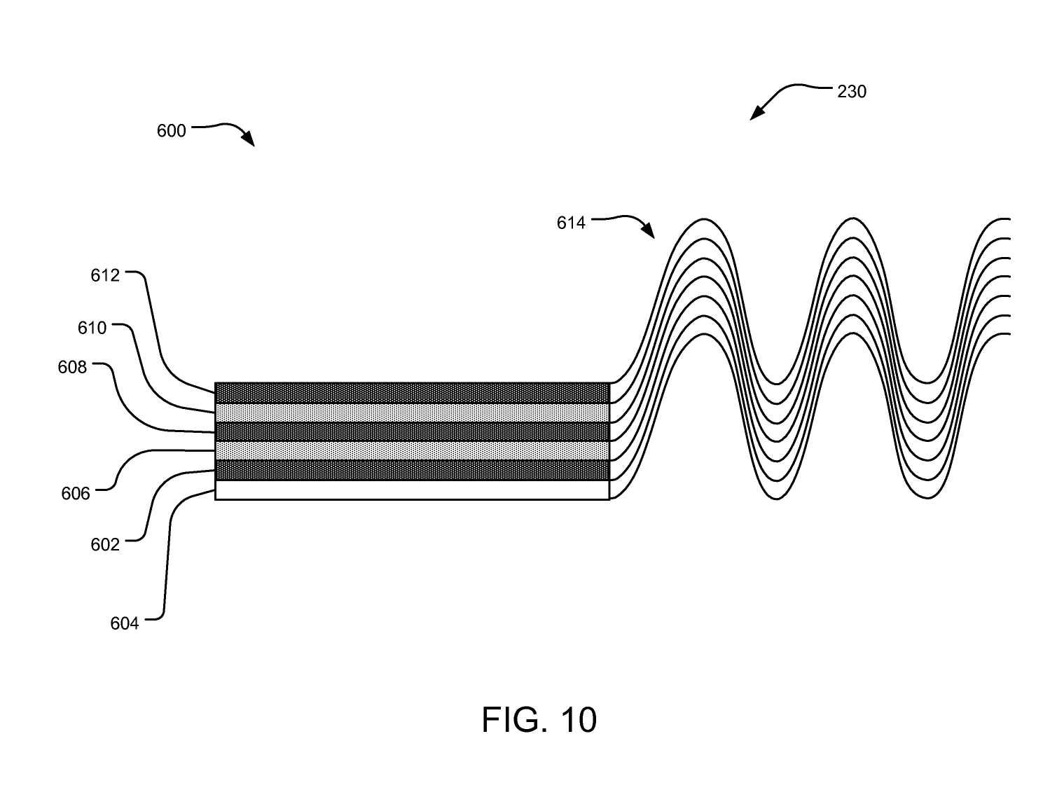

Referring to FIG. 10, in one implementation, the primary filter 230 is a composite material configuration 600 including a plurality of layers 604-612 of filter materials co-pleated into a plurality of pleats 614 using a thermal procedure or adhesive-based bonding to attach one or more additional layer(s) of filter material (e.g., layers 606 and 610), load bearing material (e.g., layers 602, 608, and 612), activated carbon for added system protection (e.g., layer 604), impregnated activated carbon, and/or the like.

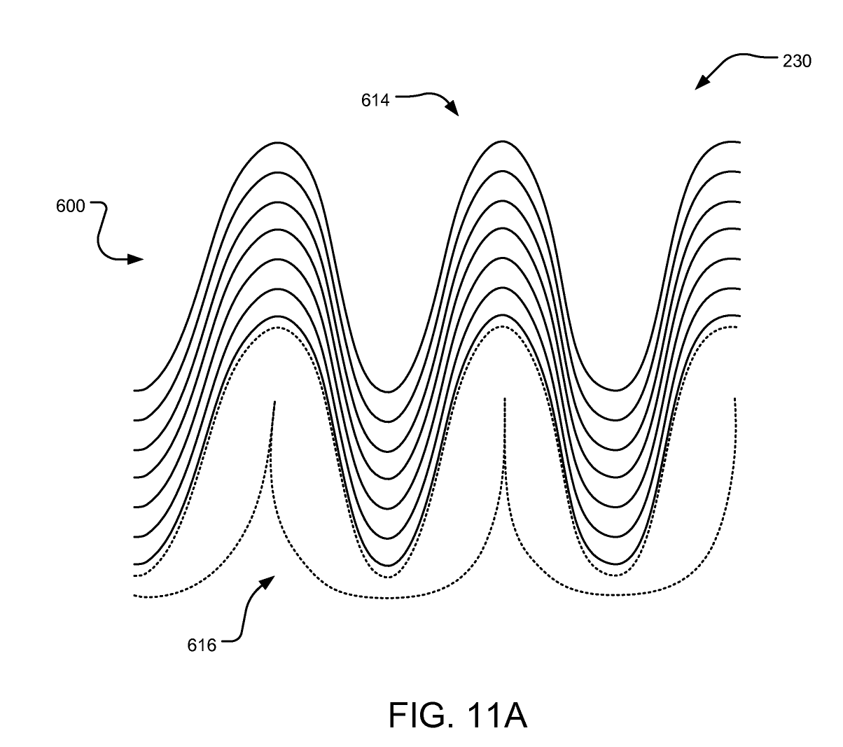

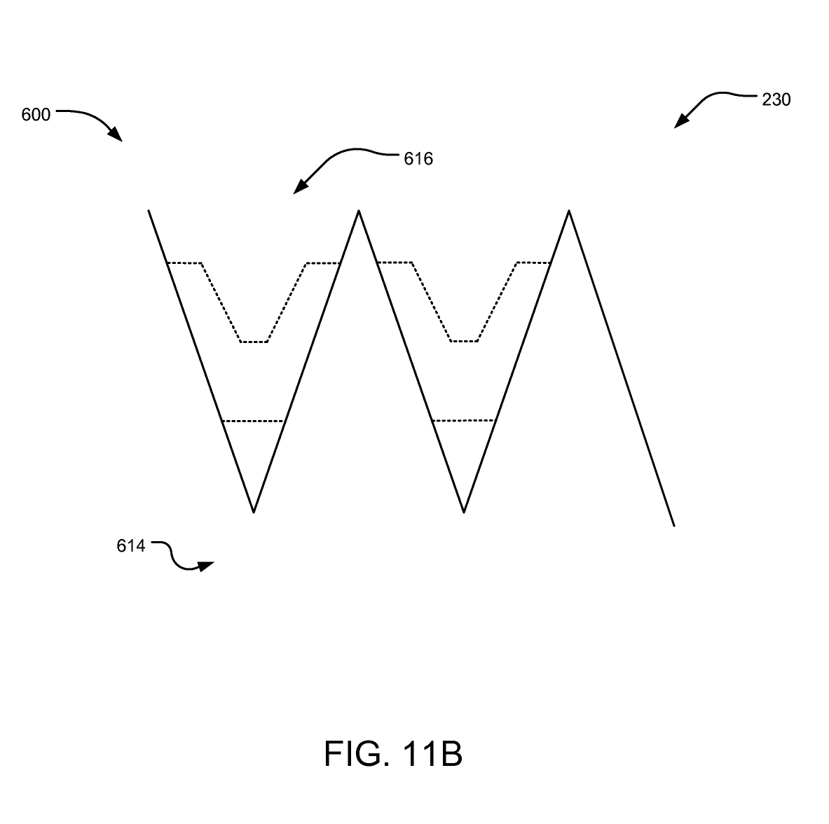

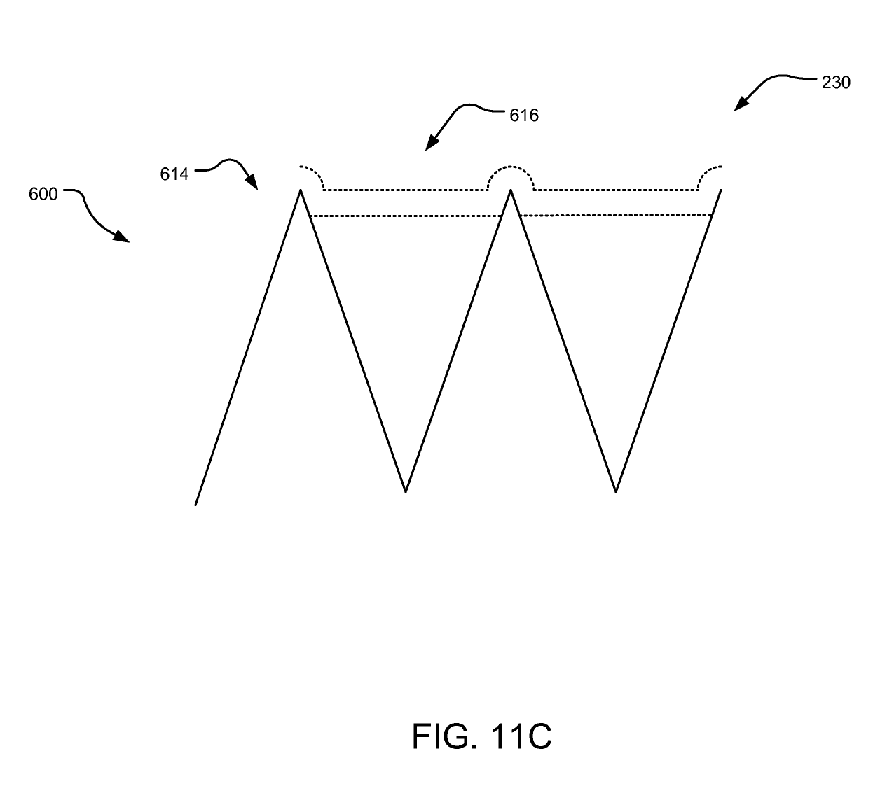

Turning to FIGS. 11A-11C, adhesive line implementations are shown. In FIG. 11A, adhesive 616 may be applied along the peaks of the pleats 614. In another implementation shown in FIG. 11B, the adhesive 616 may be applied along the valleys of the pleats 614. In still another implementation shown in FIG. 11C, the adhesive 616 may be applied along the tops of the pleats 614. The configuration shown in FIG. 11C maintains good pleat structure while reducing resistance due to the adhesive 616 and easing air flow through the primary filter 230. In some implementations, adhesive-based bonding may be used, employing adhesives having low or no outgassing.

In one implementation, the primary filter module 226 includes a plurality of the primary filters 230, which may be bonded or otherwise secured into the cartridge 308. The primary filters 230 may be bonded into the cartridge 308 using any suitable adhesive, such as medical grade adhesive, as described herein. In one implementation, the adhesive does not outgas, or has low outgassing, emissions and odors.

In one implementation, as the respirator 102 is designed to deliver filtered air to a user, it is desirable that the materials that are located in the airflow stream do not emit odors or chemicals in the form of VOC's, fine particle particulates, and/or the like via outgassing, for example. Composite filter media of the primary filters 230 may be constructed with inert materials such as PTFE and ePTFE and bound to a load bearing layer such as polyester and polypropylene using a heat process for mechanically adhering the layers (as oppose to glues/chemicals), thereby providing low to no outgassing. In one implementation, the respirator 102, as described in further detail herein, comprises a post-filter, such as an activated carbon filter, downstream of the primary filter 230 to address any potential outgassing issues. In other implementation, the primary filter 230, pre-filter 222, and/or any components susceptible to outgassing may be pre-treated to minimize future outgassing, for example via heat treatment or similar treatments.

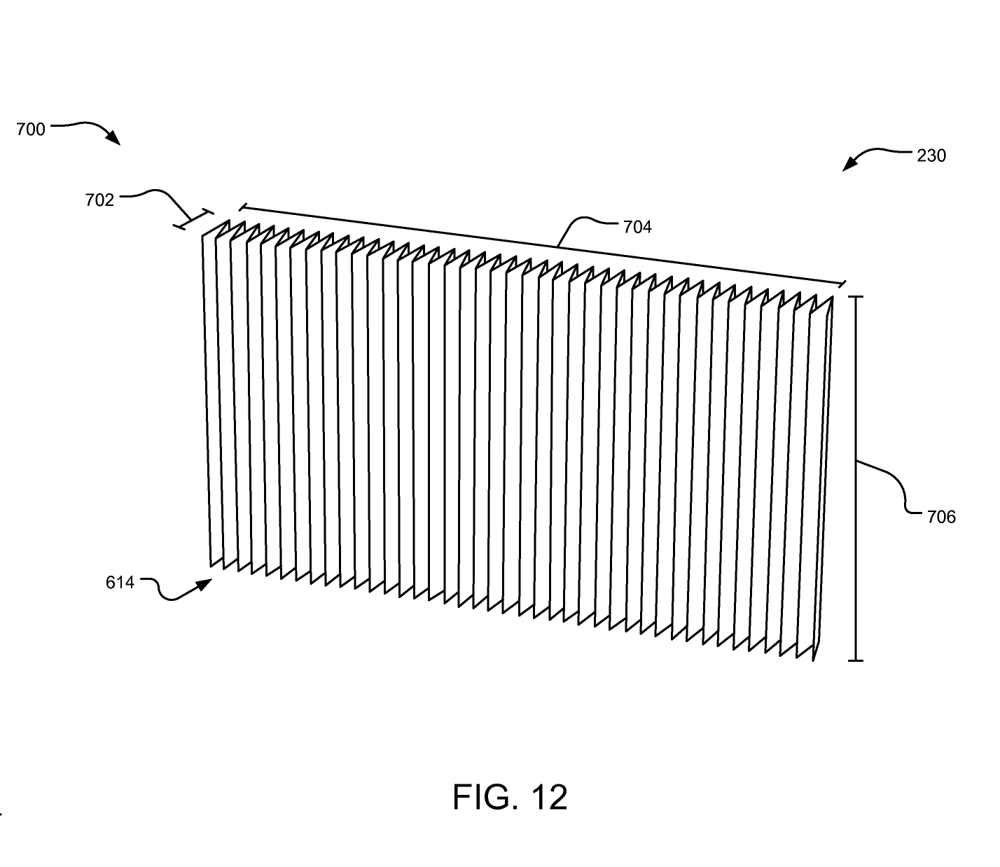

As can be understood from FIG. 12, in one particular implementation, the primary filter 230 is arranged in a pleated configuration 700 with a width 702 of approximately 0.5 inches, a length 704 of approximately 6 inches, and a height 706 of approximately 5 inches, thereby providing 6 pleats 614 per inch. Where the primary filter 230 is coupled in a parallel configuration with another filter of the same dimensions, a face velocity of generally less than or equal to 1 cm/s is generated under normal operating flow rates of 80-200 SLM. In the example implementation shown in FIG. 12, the primary filter 230 provides a system flow rate of 120 SLM and a face velocity of approximately 0.8 cm/s. It will be appreciated that the pleated configuration 700 is exemplary only and other configurations, dimensions, and parameters are contemplated.

In one implementation, the operation of the respirator 102 at low face velocities increases the duration of use of the primary filter 230. To illustrate the effect that face velocity and particle loading has on the lifetime of the primary filter 230, consider the following example. Assuming a constant (linear) rate of loading, in accordance with aspects of the disclosure, it was determined that the pressure drop of the primary filter 230 would increase by 300% if an aerosol was delivered at the low face velocity of 0.5 cm/s and filled up to 64 g/m². The amount of time it would take a user to reach this load level assuming 6 hours of daily use for a 3.45 square foot surface area primary filter 230 operating at 100 SLM with a PM 10 level equal to 150 micrograms/cubic meter, which is a pollution level that exceeds the average annual reported PM 10 level for Beijing in 2010, was calculated. Under these exemplary conditions, the primary filter 230 would last approximately 3,798 days (approximately 10 years). Decreasing the operating flow rate from 100 SLM to 80 SLM extends the lifetime of the filter from 3,798 days (10 years) to 4748 days (13 years). In summary, the high flow low face velocity design intrinsic to the respirator 102 greatly enhances the performance.

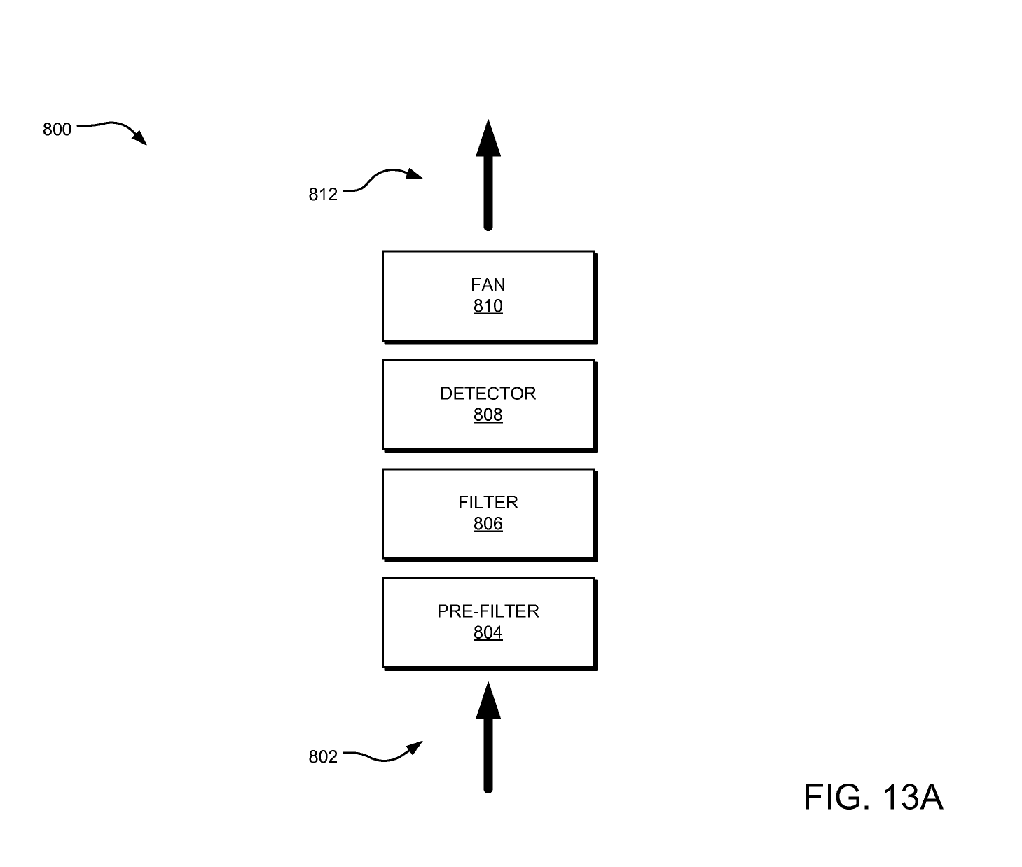

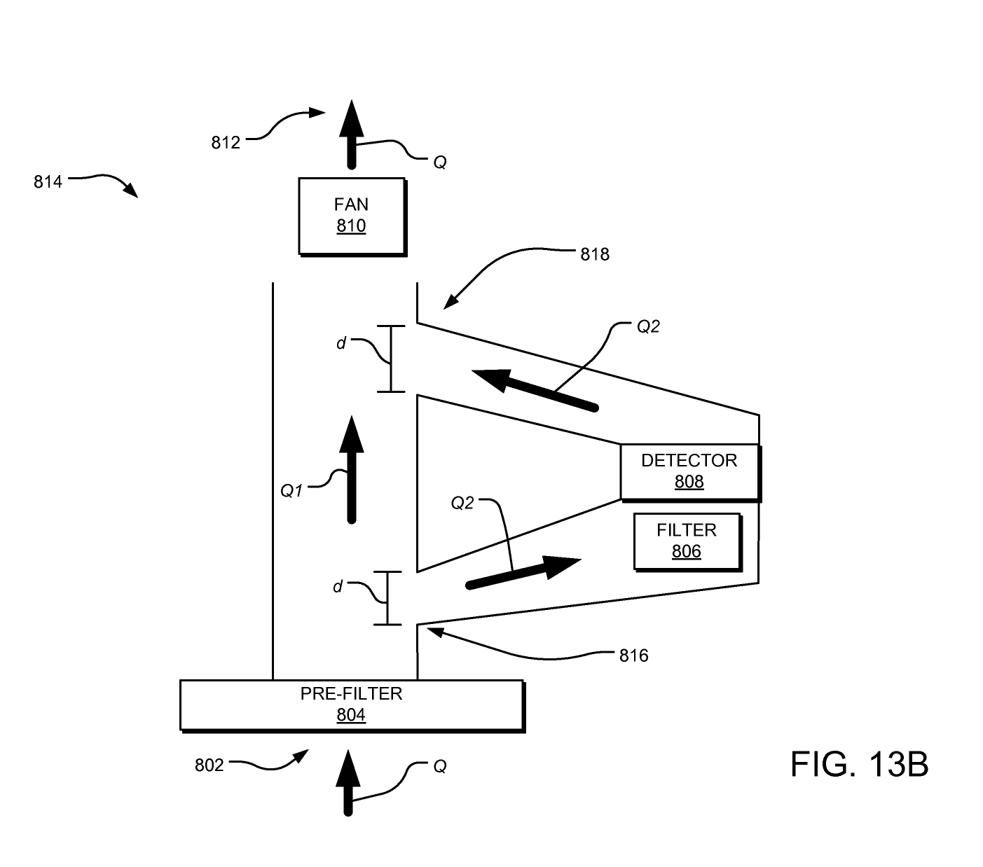

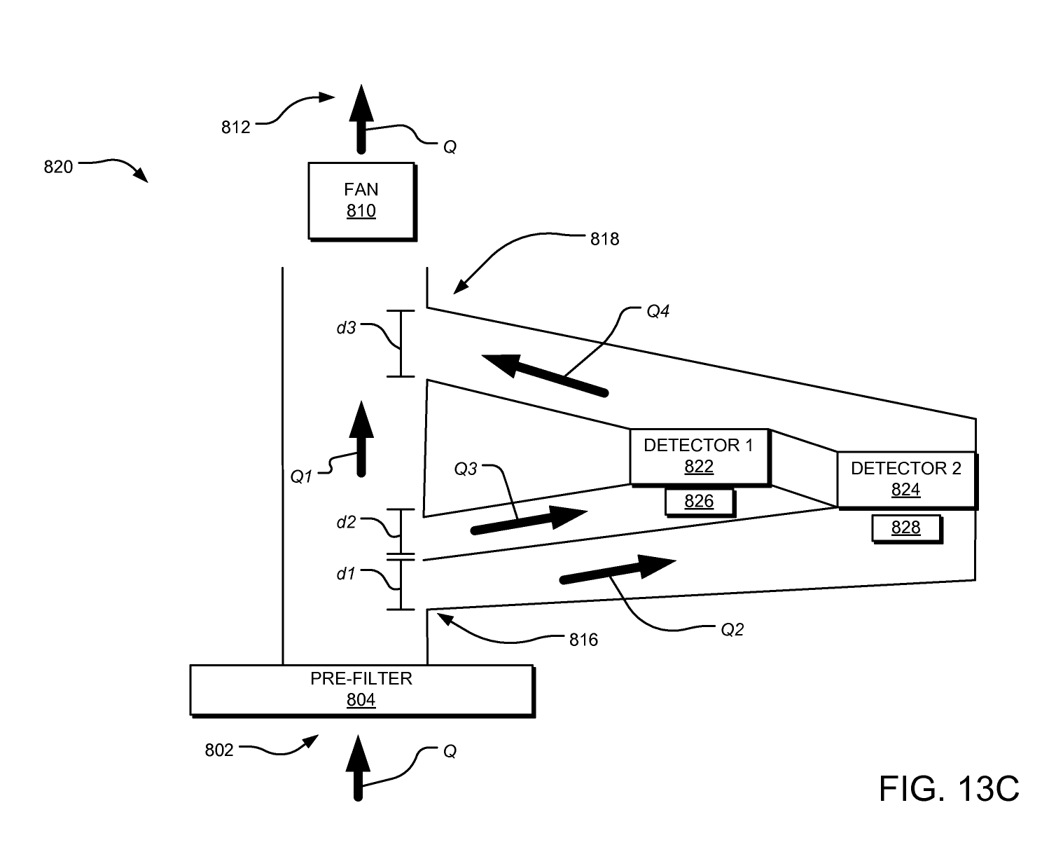

Referring to FIGS. 13A-C, example particle detector configurations are shown. In some implementations, one or more particle detectors 808 are disposed between filters 804-806 and one or more fans 810. Air inflow 802 enters through the pre-filters 804 and an outflow 812 exits through the fans 810. The particle detectors 808 are configured to detect one or more, two or more, or three or more particle detection levels. For example, the particle detector 808 may include three primary detection levels, such as >PM2.5, PM2.5, and PM10. The particle detector 808 may utilize various techniques for detecting particles of various sizes, including, without limitation, laser particle counter, optical particle counter, TOF particle sizer, inertial classifier, low pressure microorifice impactor, and/or optical microscope.

To detect particles, the fans 810 move contaminated air through the region in which the particle detectors 808 are disposed. To perform particle detection, an in-line configuration 800, where the particle detector 808 is disposed in-line with the air stream, as shown in FIG. 13A, or off-line configurations 814 or 820, where the particle detector 808 is disposed off-line with the air stream, as shown in FIGS. 13B and 13C, may be used. The off-line configurations 814 and 820 includes a point 816 where the airflow splits an a point 818 where the airflow combines before entering the fans 810. In the off-line configuration 820, the particle detectors 810 includes a first detector 822 disposed downstream from a first filter 826 and a second detector 824 disposed downstream from a second filter 828.

In one implementation, the particle detector 808 measures particulates of a specific size present in the air stream. Generally, the detector 808 is a particle “counter” that uses the filter 806 downstream of the measurement to separate out the particle size of interest. For instance, to measure PM2.5 levels would require the filter 806 to have exact dimensions to separate particles that are larger than 2.5 microns in diameter from entering the detection region. It will be appreciated that separation may be achieved by various techniques other than using the filter 806, including, but not limited to, a cyclone or virtual impaction.

Once the contaminated air flow has been filtered using the filter 806 it enters the detection region where it is illuminated with laser light. More particularly, the aerosol particles of interest are passed through a region in which the light source is illuminated, and as the particles interact with the light source they cause scattering events that are collected by the particle detector 808. The information collected by the particle detector 808 is used to quantify parameters, such as particle count (concentration) and particle size. In one implementation, a particle count may be determined by counting the pulses of scattered light that is collected by the particle detector 808. The particle detector 808 determines particle size and shape by quantifying the intensity of the scattered light. Information related to the particle size and shape may be determined from the intensity data by utilizing both theoretical and experimental (data fitting) aspects of Mie theory:

$$α = \frac{{π D}_{p}}{λ}$$

From both observation and Mie theory, it is known that the intensity of light that has been scattered from an incoming particle from an emitted light source depends heavily on the size of the particle. The intensity of light detected from a scattered particle is not a universal function and changes form depending on the ratio between the size of the particle and the wavelength of the light source. In the equation above α is the sizing parameter which is the term that determines the proper expression that for use during application of the theory. This term is typically compared to λ, which represents the wavelength of light used by the light source in the technique. For particle sizes much smaller than the wavelength of the light source, the scattered intensity is quantified from Mie theory by the equation below and is called Rayleigh Scattering. This scattering method would apply to particulates that fall in the UFP (ultra-fine particle) size range (a<<λ):

$$I = {I}_{0} ( \frac{1 + {cos}^{2} θ}{2 {R}^{2}} ) {( \frac{2 π}{λ} )}^{4} {( \frac{{n}^{2} - 1}{{n}^{2} + 2} )}^{2} {( \frac{d}{2} )}^{6}$$

For large particles, where (a>>λ), the simplified geometric scattering regime is used:

I=I₀(K_{(n,θ)})d⁶

In one implementation, the participle detector 808 includes an optical particle sensor located upstream of the pre-filter 804 and downstream of the air entry mesh 214. As described herein, this sensor uses an infrared emitting diode (IRED) and a phototransistor to detect fine particles by analyzing the pulse pattern of the output voltage. The size of particles can be distinguished by comparing pulse patterns. It will be appreciated, however, that other detection methods may be used for determining pollution particle levels of air entering the device, including, but not limited to, scattering techniques such as Rayleigh scattering (smaller particles less than the wavelength of light) and Mie Scattering (larger particles) where particular particle sizes can be singled out by proper choice (wavelength) of the source LED.

Data collected from the particle detector 808 may be used to provide information related to the PM2.5 levels in the area of a user to the user (e.g., via the user device 112) or to another interested individual or agency. This is particularly useful for areas where local PM2.5 peaks exist are much larger than what is reported for the average air quality for their general location. As an example, the detailed information related to PM2.5 levels of local areas could be used to determine the living conditions (long and short term) for a given area and influence the decision of people to reside in such a location.

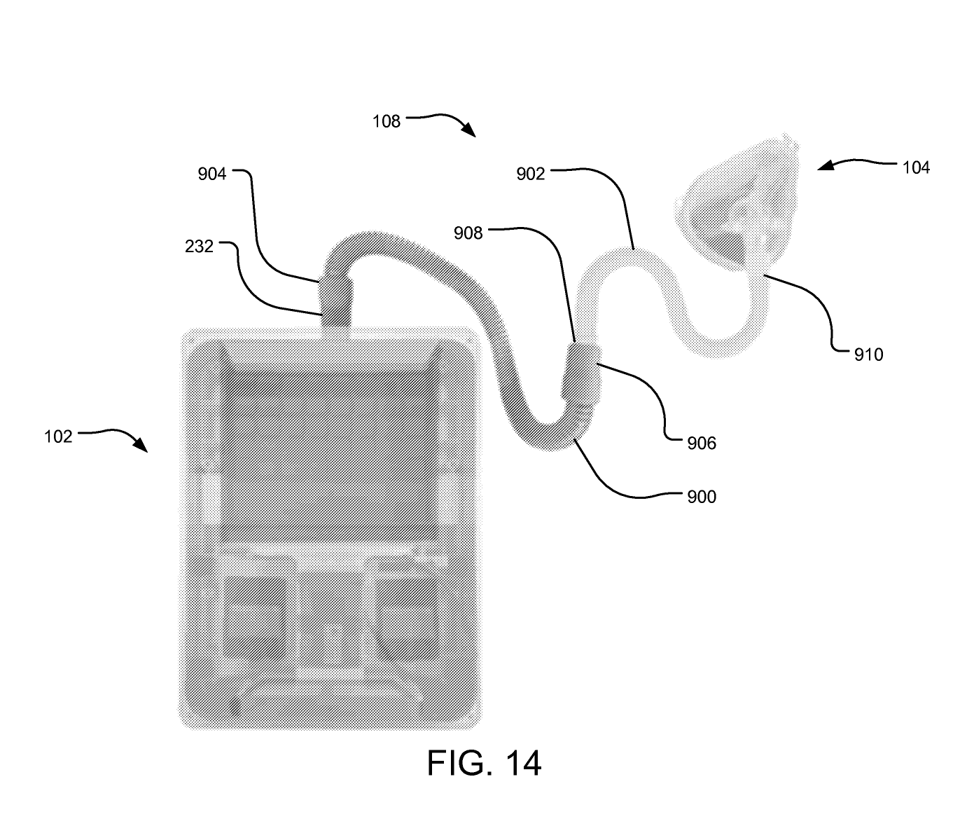

As described herein, the respirator 102 provides filtered air to an enclosed space, which may be, for example, the mask 104. Turning to FIG. 14, an example hose 108 having a tapered diameter is shown. In one implementation, the hose 108 tapers in diameter proximally. Such a tapered configuration of the hose 108 may be secured though a carrying strap of a carrying case, such that the hose 108 remains secured inside the strap out of the way of the user. Moreover, the tapering provides a lower pressure drop through the air filtration system 100 as compared to a single, larger diameter hose.

In one implementation, the tapered configuration includes a larger diameter hose 900 and a smaller diameter hose 902. As an example, the larger hose 900 may have an internal diameter of 0.75 inches and the smaller hose 902 may have an internal diameter of 0.58 inches. The larger hose 900 is connected to the air outlet 232 of the respirator 102 with a distal end 904, and the smaller hose 902 is connected to the mask 104 at a proximal end 910, which may include a flapper valve, as described herein. In one implementation, a laminar flow nozzle 906 is disposed at a region 908 of transition from larger to smaller diameter of the hose 108.

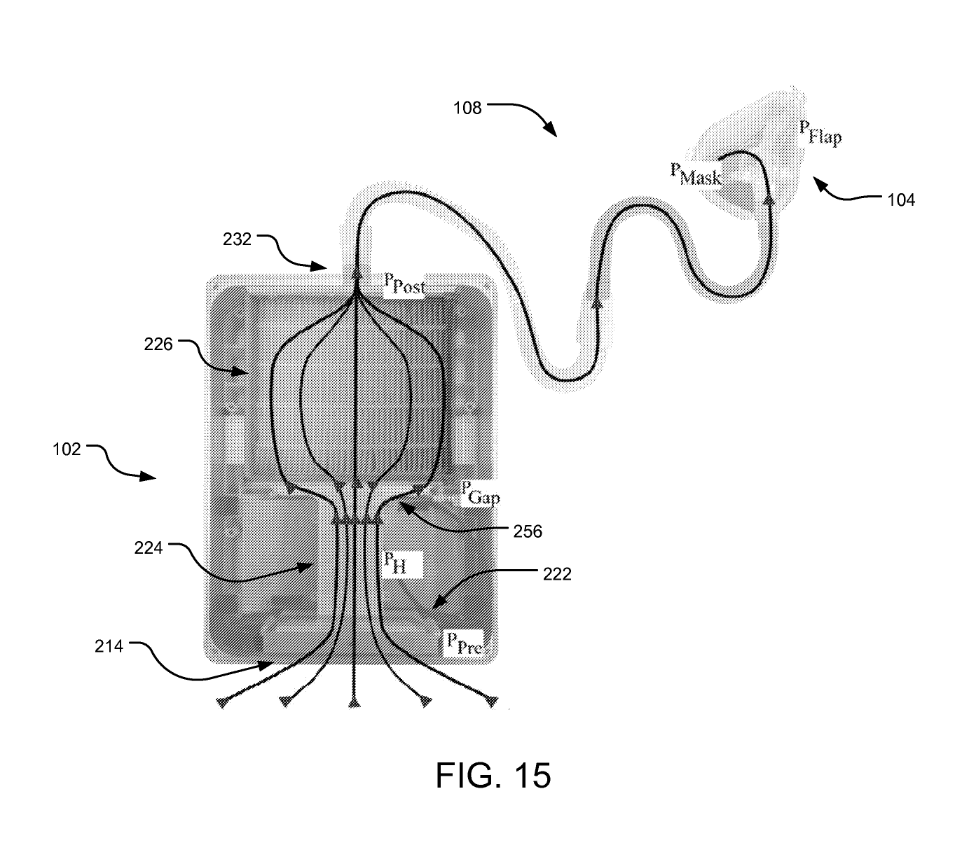

As will be understood from FIG. 15, a plurality of sensors may be located throughout the airflow path and in communication with the controller 240. In one implementation, the controller 240 receives the pressure readings and utilizes the readings to determine the pressure drop at various locations, including, without limitation, at the air entry mesh 214, the pre-filter 222, the primary filter module 226 (e.g., based on a gap between the filters), the post-filter, the hose 108, the mask 104, and the flapper valve within the mask 104. These regions can experience a press drop due to the geometric changes and restrictions.

In one implementation, the pressure drop for the entire air filtration system 100 is calculated using the following equation:

$${P}_{H} \geq {\sum }_{i}^{n} {P}_{i}$$

Here, P_{H} is the hydrostatic pressure output by the fans 224 and Pᵢ represents each aspect of the respirator 102 that could cause a pressure drop. For example, using the pressure readings from each of the components detailed above, the equation would be:

P_{H}≧P_{grate}+Pₚᵣₑ+P_{gap}+P_{filter}+Pₚₒᵤᵣ+P_{tube}+Pₘₐₛₖ+P_{flap}

The sum of each component's pressure drop must not exceed the total hydrostatic pressure that the fans 224 are capable of producing. In one implementation, the fans 224 are able to operate at 3 inches of water (IW) of pressure with a ceiling operating output of 4.8 IW. Further, in one implementation, the respirator 102 operates at a normal flow rate of 100 standard liters per minute (SLM), with a maximum flow rate of 200 SLM.

In one implementation, a pressure drop across a filter (e.g., the pre-filter 222, the primary filter 230, the post-filter, etc.) may then be used to determine if the filter needs to be replaced. For example, as a filter nears the end of its lifespan, the airflow through the filter decreases, causing the pressure drop across the filter to decrease. Once the pressure drop has fallen below a threshold, the controller 240 may trigger an indicator alerting the user of the need to replace the filter. In another implementation, the air pressure data may be used in conjunction with usage data to better determine whether the filter needs to be changed.

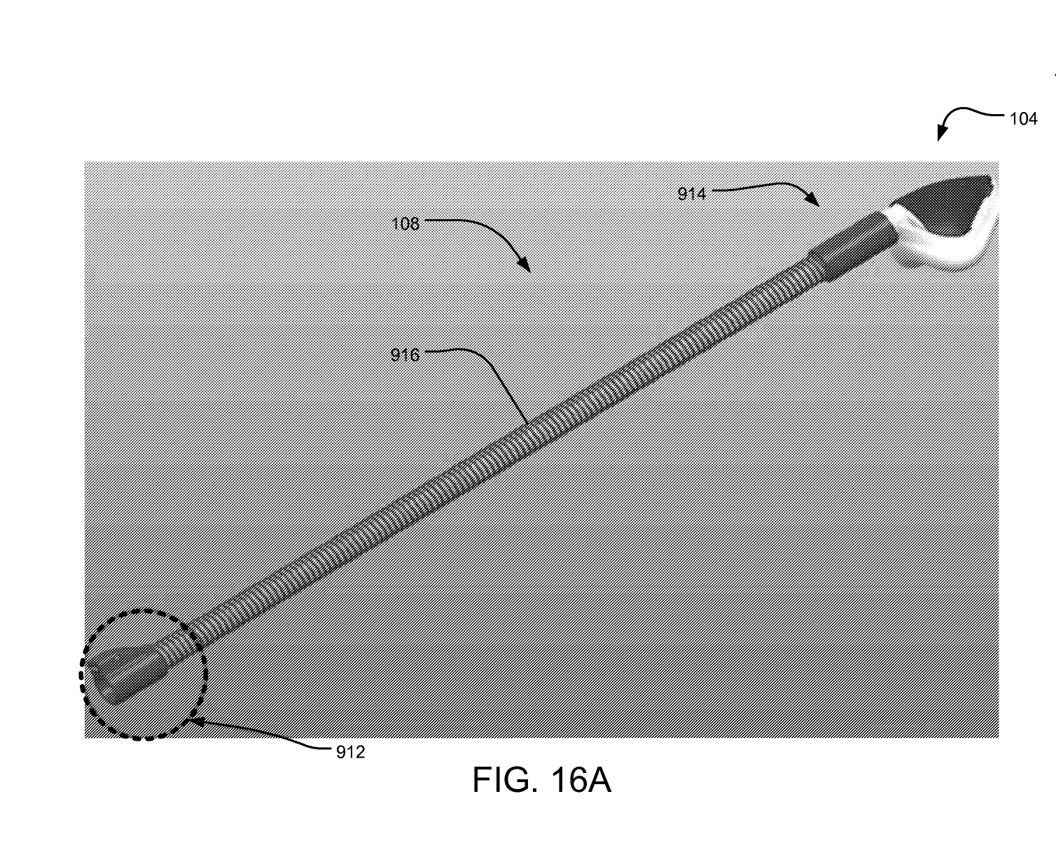

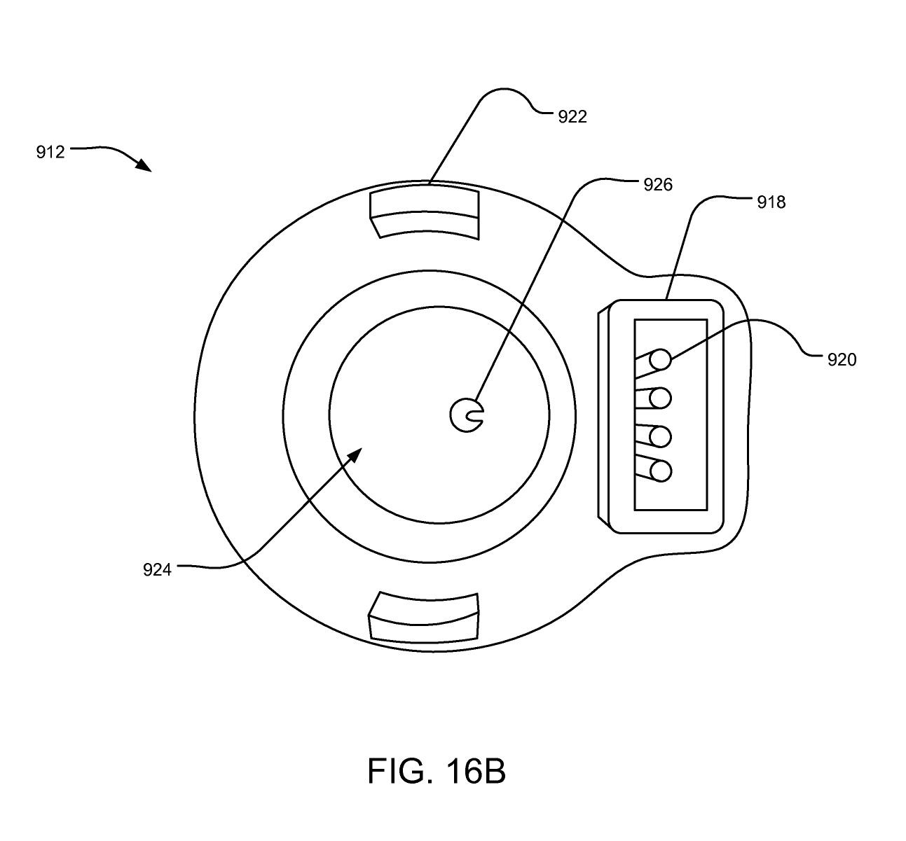

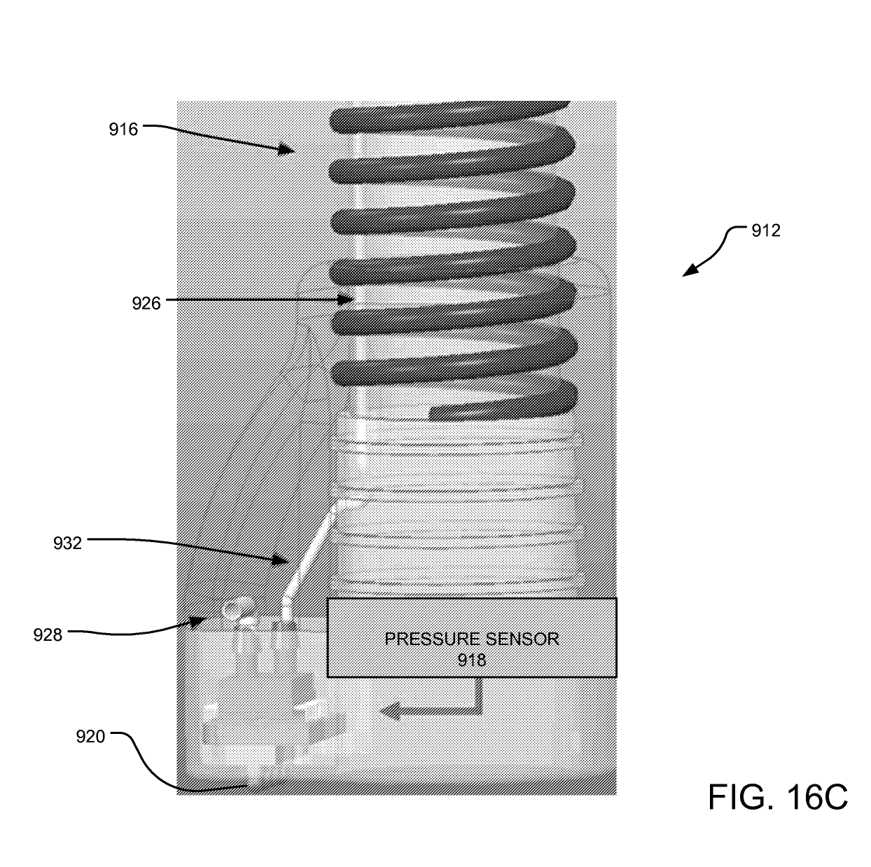

To begin a detailed discussion of the hose 108 and mask 104, reference is made to FIG. 16A. In one implementation, the hose 108 includes an elongated body 916 extending between a distal end 912 and a proximal end 914 and configured to transport filtered air to the mask 104. The distal end 912 is configured to connect with the respirator 102 at the outlet port 232, and the proximal end 914 is configured to connect with the mask 104. The distal end 912 may be connected to the outlet port 232 in any suitable manner, including, without limitation, threaded fittings, snap-on fittings, or other suitable releasable connections. The elongated body 916 may be any hose, tube, or other body with a lumen extending therethrough for transporting fluid and/or air. In one implementation, the elongated body 916 is anti-kinking.

Many conventional breathing devices have hoses that are large and unsightly, which may discourage users from daily use. As such, the hose 108 and the mask 104 balance functionality with aesthetics to provide a practical system that is desirable for daily use. In a particular implementation, the hose 108 has an inner diameter of approximately 22 mm, an outer diameter of approximately 24 mm, a wall thickness or approximately 1 mm, and a length of approximately 24 inches. In another implementation, the inner diameter ranges from approximately 16.5 mm to 38 mm, and the length ranges from approximately 0.75 ft to 4 ft. Other dimensions are additionally contemplated. Further, the hose 108 may have a variety of interior and exterior aesthetic features, including, without limitation, colors, designs, shapes, graphics, textures, translucent surfaces, transparent surfaces, opaque surfaces, and other features. For example, the hose 108 may have a smooth interior with a corrugated exterior and a clear or colored appearance. Additionally, in one implementation, the hose 108 and/or the mask 104 contain one or more surfaces that may be controlled (e.g., via LEDs or other displays), for example, with the user device 112 to change the appearance.

In one implementation, where the air filtration system 100 is used in colder climates or during colder temperatures, the hose 108 includes a resistive heating element that wraps around or is otherwise encased inside the corrugated outside region of the hose 108.

Referring to FIG. 16B, a detailed view of the distal end 912 of the hose 108 is provided. As discussed herein, the distal end 912 may be connected to the respirator 102 in any suitable manner, including, without limitation, threaded fittings, snap-on fittings, or other suitable releasable connections. For example, as shown in FIG. 16B, the distal end 912 may include one or more prongs 922 for engaging corresponding receivers in the respirator 102.

In one implementation, the distal end 912 includes a pressure sensor 918 that is configured to connect to and interface with the pressure sensor chip 248 of the respirator 102. In one implementation, the pressure sensor 918 includes a plurality of pins 920 configured to engage corresponding female receivers in the pressure sensor chip 248. Pressure readings obtained in the hose 108 and/or the mask 104 may communicated to the controller 240, as described herein, via the pressure sensor 918 and the pressure sensor chip 248 for analysis and feedback, such as an adjustment to the operational parameters of the respirator 102 or an alert to the user via the user device 112.

In one implementation, the hose 108 includes a pressure tube 926 that connects to the pressure sensor 918 and runs up a length of the hose 108 through a lumen 924 where the pressure tube 926 interfaces with the mask 104 to measure pressure inside the mask 104. The outer diameter of the pressure tube may be sized such that a pressure drop of the hose 108 is not increased by an appreciable amount.

Turning to FIG. 16C, a detailed view of the pressure sensor 918 is provided. As illustrated, in one implementation, the pressure tube 926 runs through the length of the lumen 924 for measuring pressure in the mask 104. The pressure tube 926 connects to a mask pressure tube 932 in the pressure sensor 918 to obtain pressure readings from inside the mask 104. The pressure sensor 918 further includes an outside pressure tube 928 to measure outside pressure.

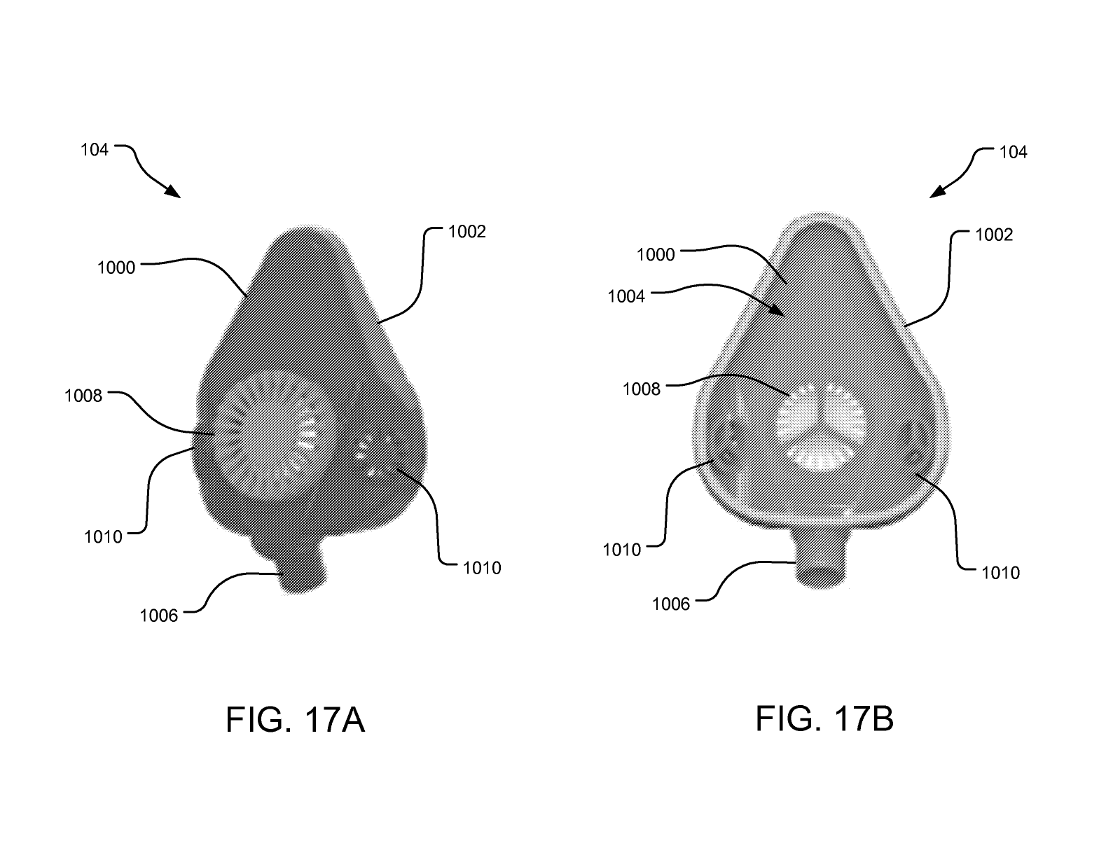

Referring to FIGS. 17A and 17B, in one implementation, the mask 104 includes a frame 1000 forming an enclosed space 1004 into which filtered air may be provided through a receiver 1006 that connects to the proximal end 914 of the hose 108. For comfort during use, the mask 104 may include a cushion 1002 over portions of the frame 1000 that are positioned on the user.

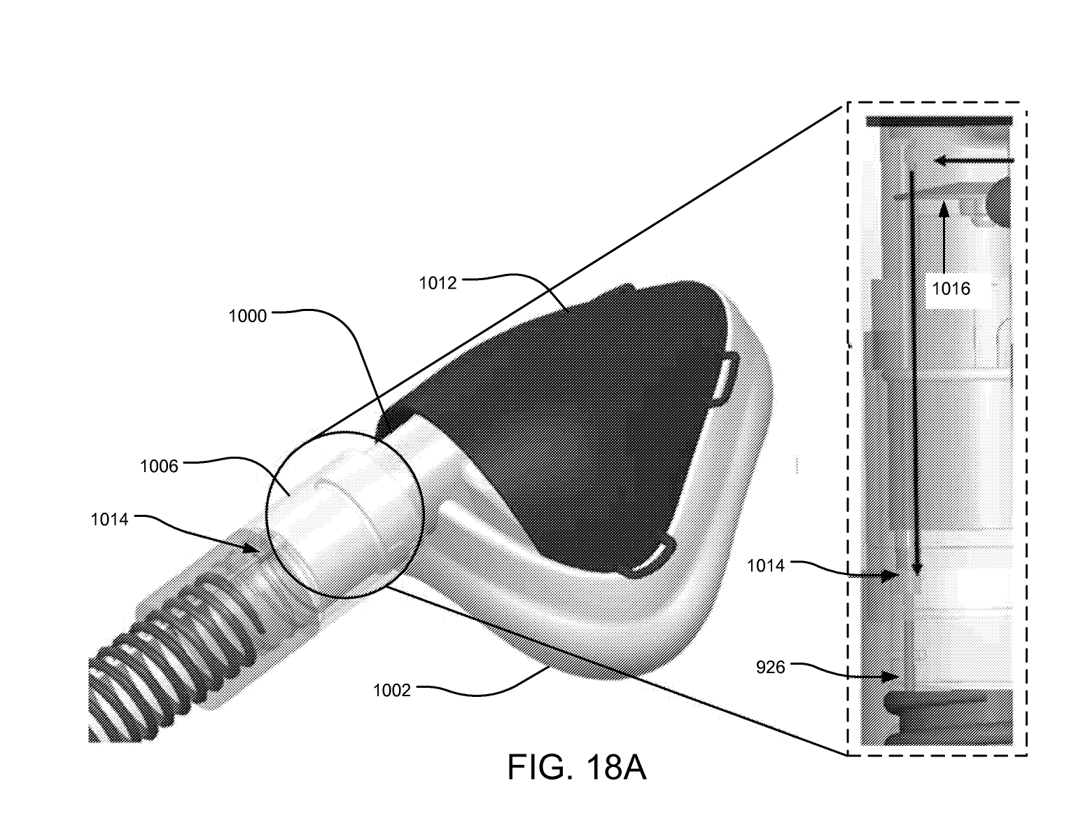

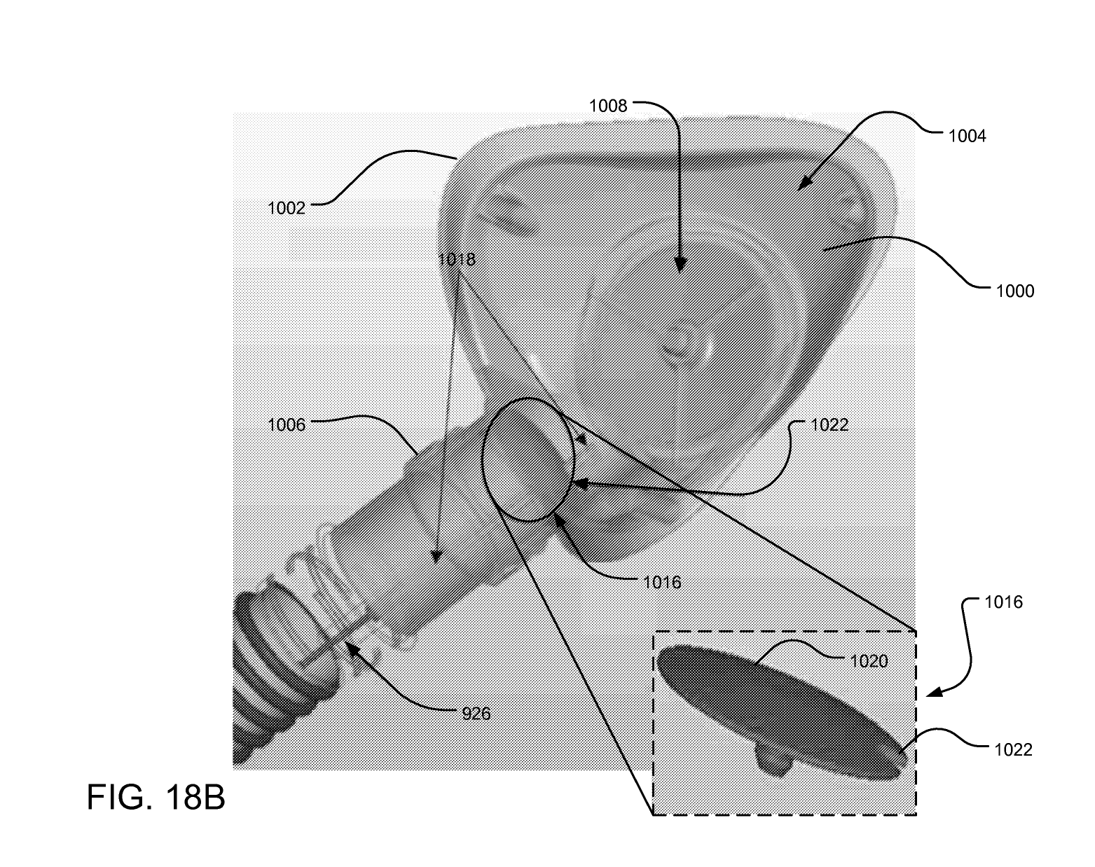

The mask 104 may be formed from a variety of materials, including, but not limited to, plastics, fabrics, glass, ceramics, metals, and/or the like. In one implementation, the mask 104 is made from a fabric type material that is breathable and comfortable. In another implementation, the frame 1000 is made from a rigid plastic and covered with interchangeable fabric cover (e.g., a cover 1012 shown in FIG. 18A). The mask 104 may include a variety of aesthetic features that may be interchangeable. For example, the mask 104 may include various colors, designs, shapes, graphics, textures, surfaces, and other features.

In one implementation, the mask 104 includes one or more a safety valves (e.g., outlet valve 1008, side valves 1010, and the back flow valve described herein). The outlet valve 1008 may be a flapper valve or other one-way valve disposed on the frame 1000 in front of the mouth of the user. In one implementation, the outlet valve 1008 and the side valves 1010 allow air into the mask 104 at low pressure but do not allow outside air to flow back into the mask 104. In addition, with the outlet valve 1008 disposed in front of the mouth of the user, the outlet valve 1008 permits sound waves to exit the mask 104 freely rather than being impeded by the frame 1000. As such, the outlet valve 1008 permits users to communicate effectively.

Turning to FIGS. 18A to 18B, in one implementation, a back flow valve 1016 is disposed in the receiver 1006 at the connection of the mask 104 and hose 108. The back flow valve 1016 may be a one way inlet flapper valve or other suitable one-way valve. The back flow valve 1016 allows air into the mask 104 at zero pressure (e.g., in the event of system failure) but would not allow air back out and into the hose 108.

In one implementation, the back flow valve 1016 includes a surface 1020 with a cut away 1022 defined therein to permit an air channel 1018 connected to the pressure tube 926 to pass therethrough. At a connection point 1014, the pressure tube 926 is fitted into the air channel 1018 to connect the air in the enclosed space 1004 of the mask 104 with the pressure sensor 918. The mask pressure path is indicated by the arrow in FIG. 18A.

The back flow valve 1016 prevents carbon dioxide build up in the hose 108. In one implementation, the back flow valve 1016 has a cracking pressure that is very low, for example, approximately 0 cmH2O. While the cracking pressure of the back flow valve 1016 may be minimized for energy consumption considerations, the functionality of the air filtration system 100 is not dependent on the cracking pressure, and the drop across the back flow valve 1016 can be as high as 1.78 cmH2O.

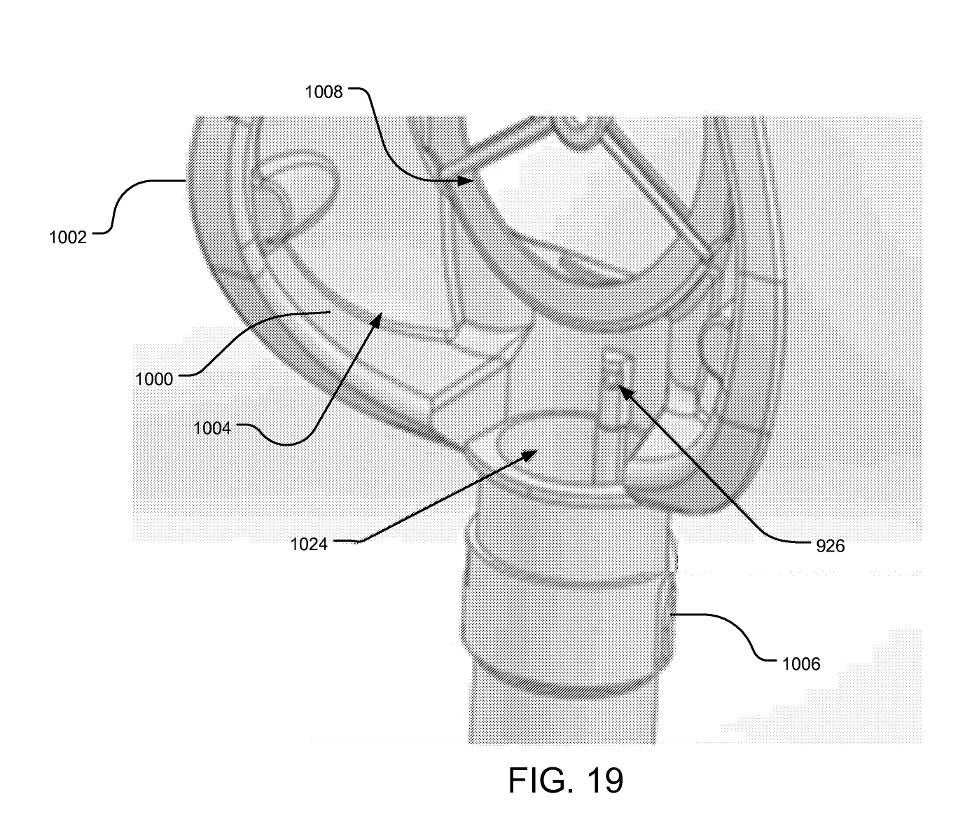

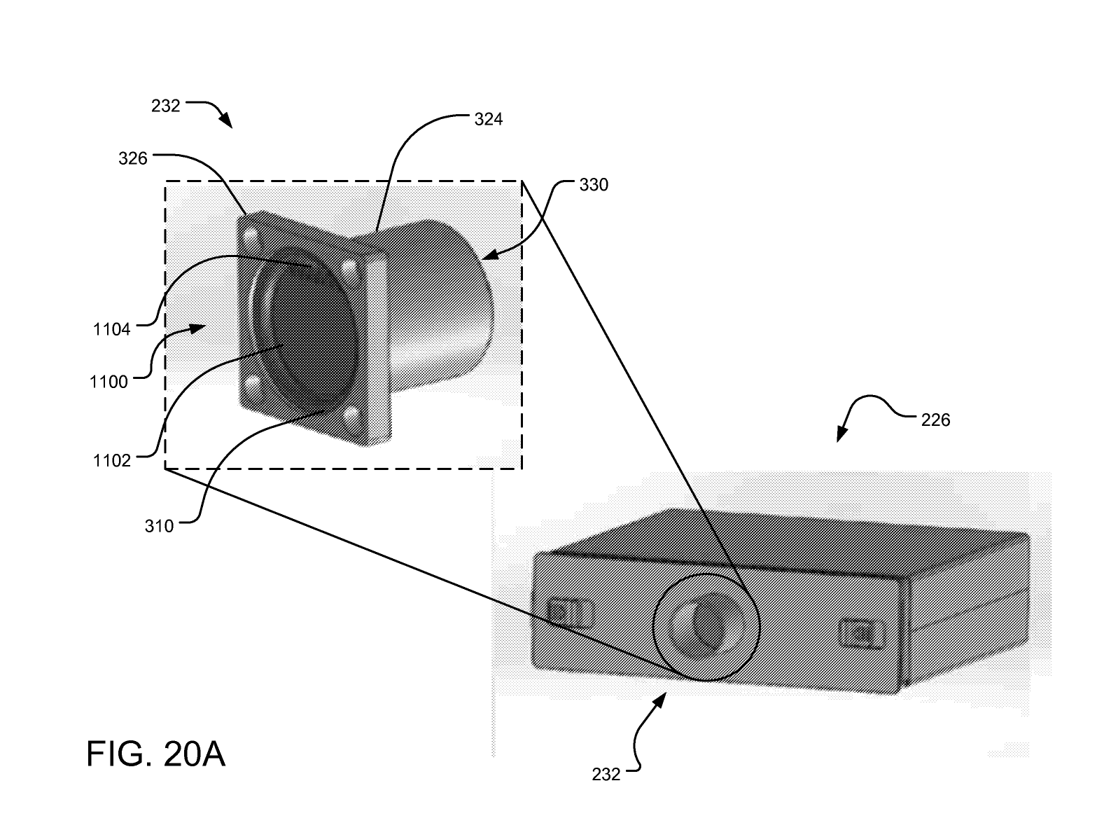

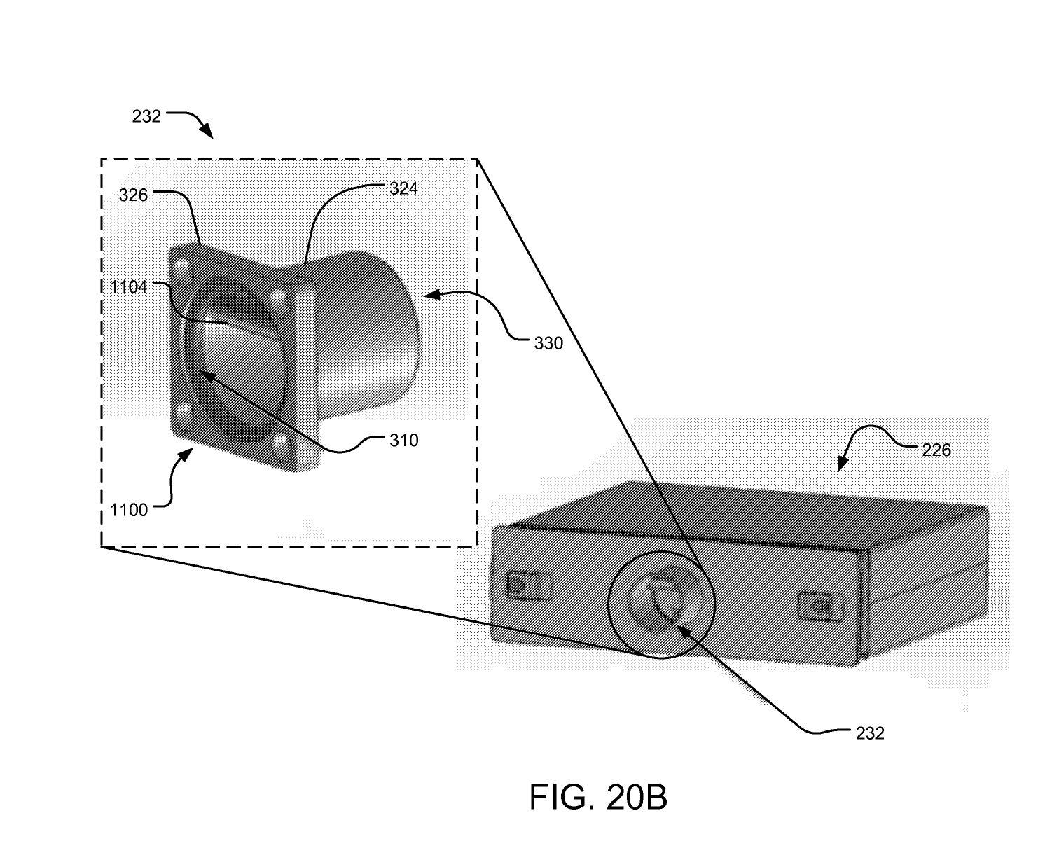

As can be understood from FIGS. 19, 20A, and 20B, in another implementation, the receiver 1006 of the mask 104 includes an uncovered opening 1024 into the enclosed space 1004. Stated differently, the mask 104 does not include the back flow valve 1016. Instead, to prevent carbon dioxide buildup inside the mask 104 and/or the hose 108, in one implementation, a back flow valve 1100 is connected to the O-ring 310 in the outlet port 232 of the respirator 102.

The back flow valve 1100 should have a minimum effect on the resistance to the air stream flow. As such, in one implementation, the back flow valve 1100 comprises a flapper 1102 with a modeled stop rib and a hinge 1104, thereby creating a doorway style valve, which reduces the resistance to air flow. It will be appreciated that the back flow valve 1100 may be any type of valve configured to prevent back flow, including, without limitation, an umbrella, a duck bill, a butterfly, and a ball valve. Further, the back flow valve 1100 does not need to achieve perfect sealing, and as such, a flat disc of inert material, such as silicone, may also be used for the back flow valve 1100. As described herein, the back flow valves 1016 and 1100 eliminate buildup of carbon dioxide inside of the mask 104 to prevent suffocation, for example, when the user has the mask 104 on with respirator 102 turned off, such that the fans 224 are not running. Together with the outlet valve 1008, the side valves 1010, the back flow valve 1016 or 1100 prevents carbon dioxide from building in the hose 108, with the majority of any carbon dioxide present being dispelled from the mask 104 through the valves 1008 and 1010 when the user exhales.

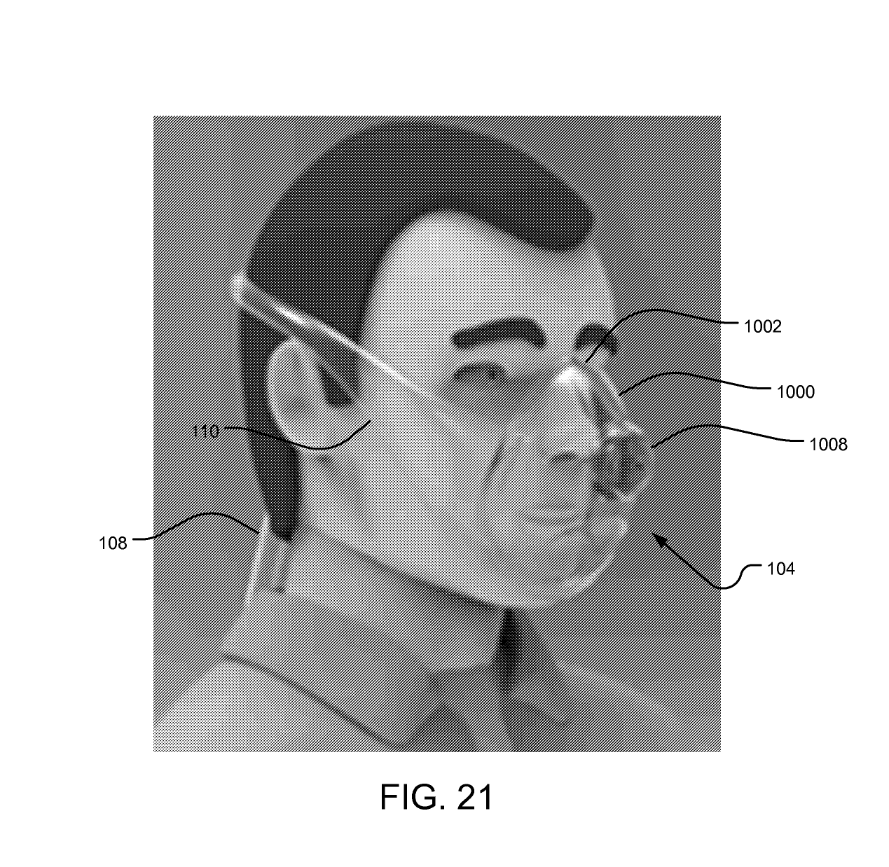

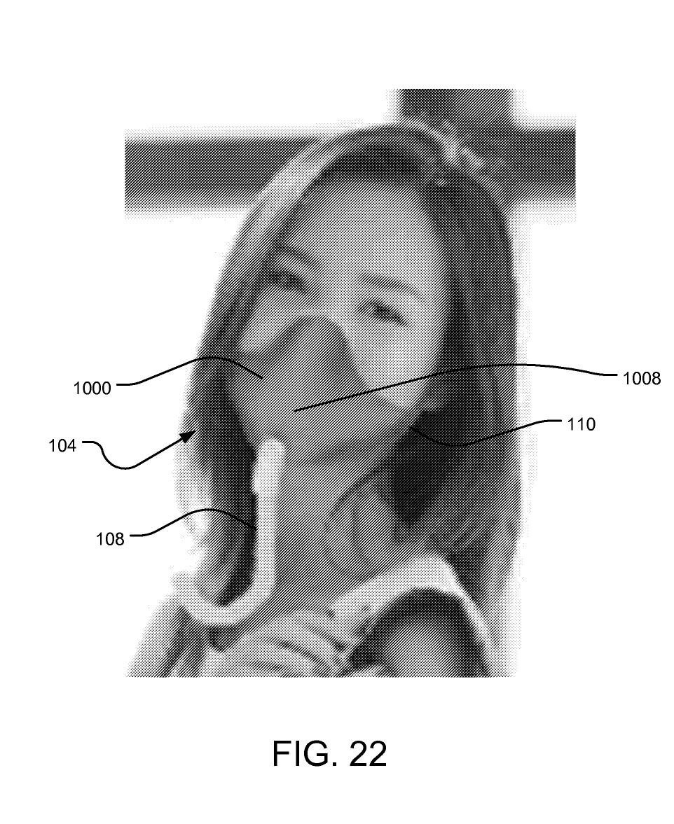

For other example configurations of the mask 104 and the hose 108, reference is made to FIGS. 21 and 22. As shown in FIG. 21, in one implementation, the hose 108 may run from the respirator 102 to a side attachment of the mask 104, which also functions as the straps 110. The mask 104 may be made from an elastic, soft rubber that allows air to pass through openings at the side connections of the straps 110 to the mask 104. The side connections of the straps 110 may include one or more back flow valves to aide in prevention of buildup of exhaled CO2 in the hose 108 and/or straps 110, as described herein. The mask 104 may also include the outlet valve 1008. The example configuration shown in FIG. 21 minimizes a visible hose 108 from the bottom of the mask 104, thereby providing a more aesthetically appealing product. This configuration may also facilitate use by small children and infants, as the hose 108 is not in arm's reach and may not easily wrap around the neck of the user. With the hose 108 out of the way, this configuration may further be useful for users who need more freedom of movement, for example, during physical activities.

Turning to FIG. 22, the straps 110 are configured as a neck attachment, wherein the mask 104 attaches via the neck of the user along the jawline, such that no attachment straps interfere with the user's hair or ears and a more aesthetically pleasing product is provided.

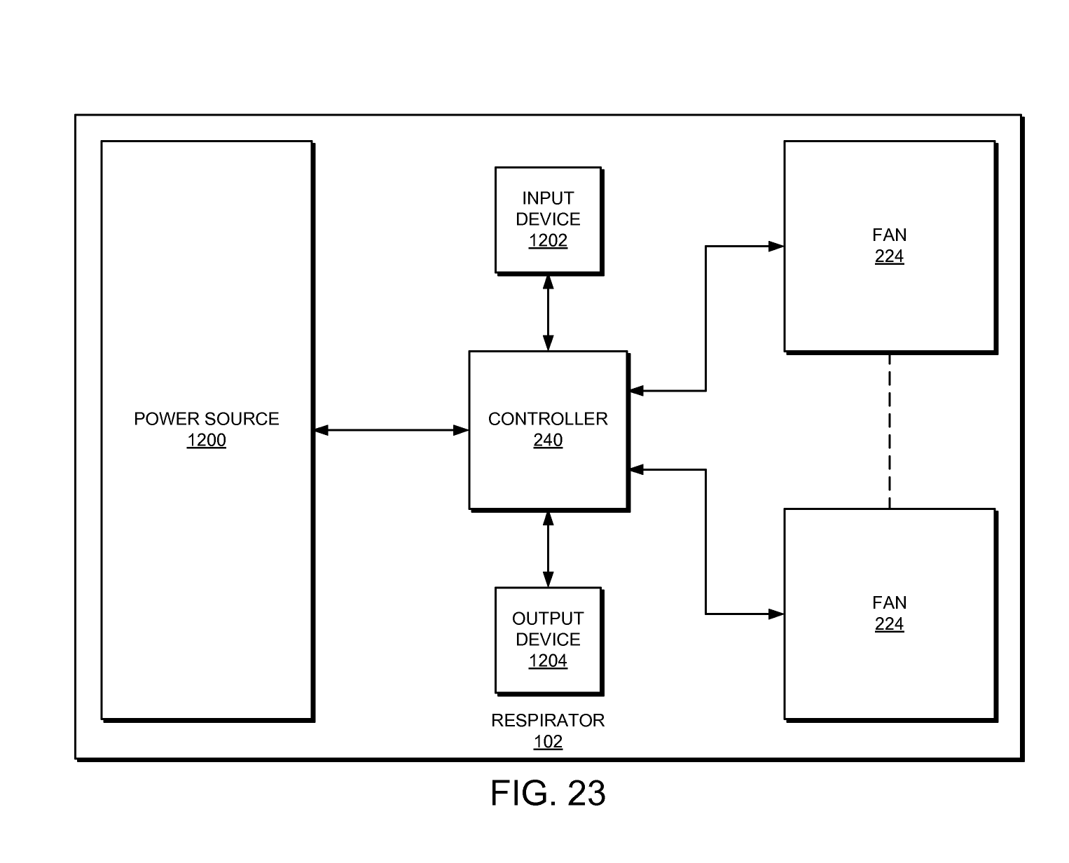

To continue a detailed description of the components of the respirator 102, reference is made to FIG. 23. As described herein, the primary filter module 226, when coupled with an optimized flow rate from the fans 224, filters UFPs at superior filter and power efficiencies. In one implementation, the primary filter 230 consists of a large network of closely spaced non-woven fibers made from a material such as PTFE or PET. The fibers have a certain diameter, porosity (ratio of the number of fibers to the number of vacancies), and thickness that all contribute to the overall filter efficiency or “particle collection” efficiency. Particles in the primary filter 230 and other pre-filters and post-filters may be trapped or collected by four mechanisms, three of which are mechanical and one of which is electrical. In one implementation, the four trapping mechanisms are: inertial impaction (large particles diverted in to filter fiber due to inability to follow airstream), interception (particles are intercepted/caught in between filter fibers), diffusion (particles small enough to interact with air molecules “random walk” into a filter fiber), and electrostatic attraction (fibers are charged and collect oppositely charged particles).

As can be understood from FIG. 23, the respirator 102 includes a variety of electrical components for controlling the operation of the air filtration system 100. In one implementation, the respirator 102 includes the controller 240, one or more input devices 1202, one or more output devices 1204, a power source 1200, such as the power source 242 described herein, and one or more fans 224, such as the stacked serial axis fans described herein.

The controller 240 receives power from the power source 1200 and manages the distribution of the power to the various other components in the respirator 102. In one implementation, the controller 240 provides power to the fans 224 and a signal indicating a status of the operations to the output device 1204 according to user input. The controller 240 accepts the user input via the input device 1202 and dictates the operation of the respirator 102. Specifically, a user may manipulate the input device 1202 to cause the controller 240 to vary the speed of the fans 224 and consequently the flow of filtered air to the mask 104.

In one implementation, the input device 1202 is configured to allow a user to manipulate the operation of the respirator 102. The input device 1202 may include electromechanical devices such as switches or buttons or may include electronic devices such as a touch screen. The input device 1202 may be directly connected to the controller 240 using a wired or wireless connection. In one implementation, the input device 1202 includes the user device 112 and/or any controls in the mask 104, the hose 108, and/or the respirator 102. For example, the input device 1202 may include a single button protruding outward from a side of the respirator 102 that can be found by touch without actually having to see the button. The button is triggered by squeezing and may include a contoured shape so that a finger naturally comes to rest on the center of the button.

The input device 1202 may further be running an application executed by a process to generate a graphical user interface (GUI) that accepts user inputs via a touchscreen or other input method, as described herein. In one implementation, the input device 1202 may be used to turn the respirator 102 on and off, select a desired fan speed, change the aesthetics of the respirator 102 (e.g., using LEDs or one or more displays configured to display designs, colors, and/or graphics).

In one example, the respirator 102 is configured to operate at low, medium, and high settings for the fans 224. The input device 1202 provides a medium for the user to select the fan speed. In one implementation, the input device 1202 is a button that when depressed, provides the controller 240 with a signal. The controller 240 receives the signal and is configured to cycle through the various modes of operation.

The output device 1204 may include any device capable of providing visual, audible, and/or tactile feedback to the user to indicate a state or status of the respirator 102. The output device 1204 and the input device 1202 may be the user device 112. In one implementation, the output device 1204 receives a signal indicative of a status from the respirator 102 and provides an output for the user. The signal provided by the controller 240 may include an analog or digital signal for conveying the state or status.

In one implementation, the output device 1204 includes one or more alerts configured to indicate whether the respirator 102 has been activated, a current state of the power supply 1200, a change filter indicator, a current fan speed of the respirator 102, and/or any other relevant status. In this example, the controller 240 may provide analog voltage signals to cause LEDs corresponding to the status to become illuminated. For example, the LEDS may be configured to include a power charge indication, a power on indication, a fan speed indication and a change filter indication. The power on LED may include a single white or other colored LED that indicates when the respirator 102 is powered on.

The power charge indication may include a group of five single color LEDs used to indicate the current charge level of the power source 1200. When the power source 1200 is near 100% charge, all five LEDs are illuminated. Four LEDs are illuminated when the power source 1200 drops to 80% charge, three LEDs are illuminated when the power source 1200 drops to 60% charge, two LEDs are illuminated when the power source 1200 drops to 40% charge, and one LED is illuminated when the power source 1200 drops to 20% charge.

The fan speed indication may include three single color LEDs. A single LED is illuminated when the fan speed is set to low, two LEDs are illuminated when the fan speed is set to medium, and three LEDs are illuminated when the fan speed is set to high. The change filter indicator may include a bi-color LED that is off when the filters are in acceptable condition, amber or yellow when the pre-filter 222 needs to be replaced and red when the primary filter 230 needs to be replaced.

In another implementation, the output device 1204 includes a display, such as a liquid crystal display (LCD) screen that displays text and other graphical indicators for the output. In this case, the controller 240 would provide an appropriate digital signal for displaying a status on the display. In some cases, the LCD may be on the user device 112 or other remote device.

As described herein, when the user device 112 or other computing device is utilized, the computing device may serve as both the input device 1202 and the output device 1204. As described above, the output device 1204 may include computing devices such as smart phones, tablet computer, and personal computers running applications configured to receive inputs from the user and display the current status to the user. In one implementation, the user device 112 generates a GUI that allows the user to both control the operation of the respirator 102 and display a current status of the respirator 102. In this example, the output device 1204 may be connected to the controller 240 via a wired or wireless connection.

The output device 1204 may further include a speaker capable of producing audible tones for indicating the status. In this example, the controller 240 is configured to provide the output device 1204 with an analog signal that causes a desired sound or series of sounds to be played by the speaker. In another example, the output device 1204 may include a vibration device capable that is provided with a signal for producing different vibration patterns depending on the status.

In one implementation, the controller 240 is configured to manage the operation of the fans 224 that draw air through the filters and provide a user with clean air. The controller 240 is configured to draw power from the power source 1200, receive an input from the input device 1202, provide power to the fans 224, and drive an output on the output device 1204. The controller 240 may be implemented using a variety of computing devices. For example, the controller 240 may be implemented using a general purpose computer or using smaller embedded systems such as systems utilizing a microcontroller, microcomputer, field-programmable gate array (FPGA), or other integrated circuit or combination of circuits.

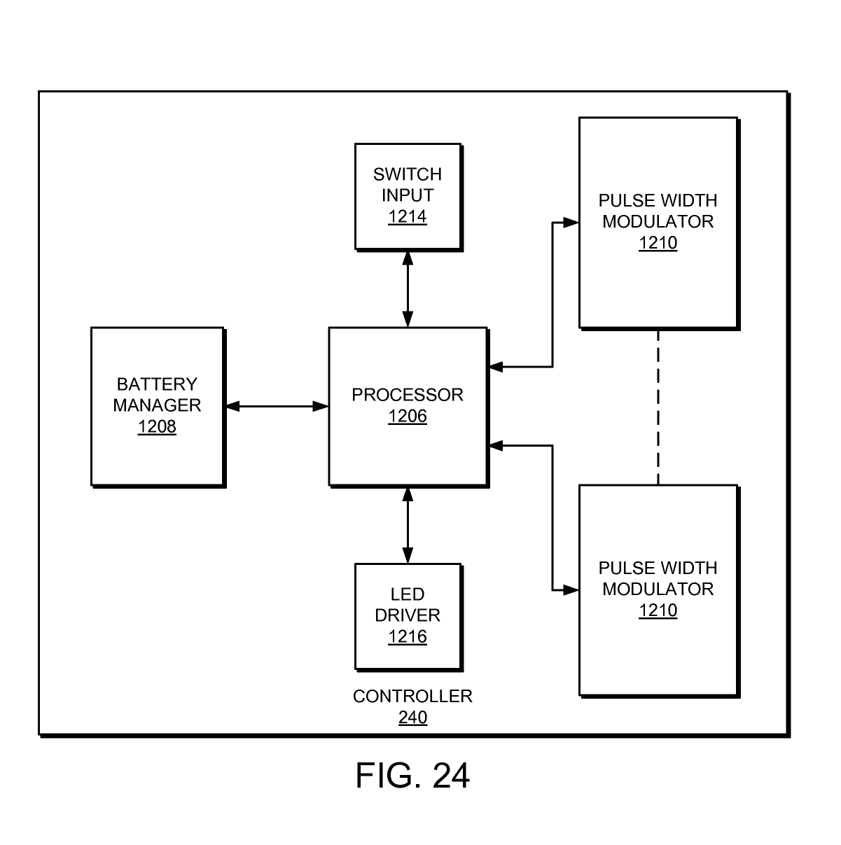

Turning to FIG. 24, a more detailed description of the controller 224 is provided. In one implementation, the controller 240 includes a battery manager 1208 for controlling the charging and discharging of one or more batteries included in the power source 1200, at least one switch input 1214 for receiving a signal or other communications for the input device 1202, at least one output for indicating or sending a status of the respirator 102 (e.g., a LED driver 1216), and a power output device for each of the fans 224, such as pulse width modulators (PWMs) 1210 for supplying each of the fans 224 with a power signal.

The PWMs 1210 may be configured to output a power signal at a frequency within the frequency range used by the fans 224. For example, the fans 224 may operate with a peak performance when supplied with a 25 kHz power input. Thus, the controller 240 may operate the PWMs 1210 at a frequency of 25 kHz. Furthermore, the speed of the fans 224 may be varied by altering the duty cycle of the PWMs 1210. For example, a low setting may be set at a 10% duty cycle, a medium setting may be set at a 50% duty cycle, and a high setting may be set at a 100% duty cycle.

The output of the PWMs 1210 is dictated according to the user input and/or the batter manager 1208. In one example, beginning when the respirator 102 is turned off, a button connected to an input on the controller 240 may be pressed to activate the respirator 102. Various fan speeds may be cycled through by additional button presses. For example, an additional press of the button may cause the controller 240 to activate the PWMs 1210 at the example 10% duty cycle thereby driving the fan(s) 224 at the low speed. An additional press of the button may cause the controller 240 to up the duty cycle to 50% and thereby drive the fan(s) 224 at medium speed, and yet another press of the button may cause the duty cycle to be increased to 100% and the fans 224 to be driven at the high speed. Additional button presses may continue the cycling through the various fan speeds. In one example, each press of the button causes the fan speed to cycle from low, to medium, to high, to medium, and back to low. In this example, the respirator 102 may be deactivated at any time by pressing and holding the button for a preset time, such as several seconds. In another example, each press of the button causes the fan speed to cycle from low, to medium, to high, to turning the respirator 102 off. The controller 240 may also automatically reduce the duty cycle of the PWMs 1210 according to the current status of the power source 1200, as monitored by the battery manager 1208, to prolong operation.

In one implementation, the battery manager 1208 determines battery charge levels, predicts battery life, and manages the charging of the battery when respirator 102 is connected to a power source using the AC/DC converter. The battery manager 1208 may be configured to override a user selected fan speed and decrease the fan speed according to a current battery life or availability of other power sources. For example, if the battery life drops below a threshold and the fan speed is set to high, the controller 240 may automatically drop the fan speed to medium once the charge threshold is reached. Similarly, if the fan speed is set to medium and the battery charge falls below a second threshold, the controller 240 may automatically reduce the fan speed to low.

In one implementation, the battery manager 1208 includes a charger and is configured to connect the controller to one or more batteries. The charger supports the simultaneous charging and discharging of the batteries. In one example, the charger includes a single charger stage connected to the batteries via a charge MUX. The charge MUX is configured to allow for the charge current to be shared between each of the batteries while preventing charge transfer between the batteries. When charging a single battery, the battery manager 1208 adjusts the total current supplied by the charger to match the current required to properly charge the battery. When there is more than one battery being charged, the battery manager 1208 compares the desired charge currents for charging each battery. The minimum charge current is then provided via the charge MUX to each of the batteries. In this example, the battery manager 1208 does not allow the charge current to exceed the current required by any battery. Charging operates independent from the remainder of the operation, allowing for the batteries to be charged regardless of whether the respirator 102 is turned on or off, so long as the respirator 102 is attached to an external power supply.

The controller 240 may also be configured to monitor the status of the filter and provide feedback to the user. In one implementation, the controller 240 logs when a filter is changed and tracks filter usage by logging the amount of time that the respirator 102 has been used. An alert may then be generated when the filter usage is close to or has exceeded the projected lifespan of the filter. The filter usage data may also be adjusted by logging the amount of time at each speed that the filter has operated. Once the filter usage limit is reached, an indicator to change the filter may be activated. For example, an LED may be lit to indicate that the filter needs to be changed. In another example, a tri-color LED may be used to indicate that a filter is good, needs to be changed soon, or needs to be changed immediately. The indicator may also be triggered on the user device 112 or other remote device.

In particular implementation, the respirator 102 has four operational modes dictated by the controller 240. The modes include an off mode, an on mode with LEDs illuminated mode, an on mode without the LEDs illuminated, and a warning mode. In this example, the off mode is a very low power mode similar to a standby mode. The respirator 102 only consumes a small amount of power when in the off mode and operations are limited to recognizing an input being received from the input device 1202 and turning on. Once the input is received the respirator 102 goes into the power on with LEDs illuminated mode. In this mode, the respirator 102 will accept fan speed setting changes and a command for powering off. The LEDs will be illuminated to relay the state of the respirator 102, for example, indicating the fan speed, battery charge, and whether the filter needs to be replaced. In the power on with no LEDs illuminated mode, the fan 224 is kept at its current speed and the only command that the controller 240 will recognize is to power off. The warning mode is triggered when the respirator 102 is engaged in one of the on modes and a problem emerges. For example, the warning mode may be activated when battery is running low. In this case, a low battery LED may be illuminated or begin flashing. Similarly, when the filter needs to be changed an LED may be illuminated.

In one particular implementation, the controller 240 includes a DC power input and a protection circuit configured to protect against a reverse polarity power input. When connected to an external DC power supply, the controller 240 controls both the operation of the respirator 102 and the charging of the batteries. To charge the batteries, the controller 240 measures the voltage of each battery and controls a charging current using a series of MOSFETs or other switches. Once the DC power supply has been disconnected, the controller 240 switches to drawing power from the batteries. In this example, the controller 240 includes two microcontroller units operating in a master/slave configuration. The slave microcontroller is configured to control the output devices 1204, in this case by supplying the LED driver 1216 with a signal for lighting a plurality of LEDs to indicate current operational state. The slave microcontroller unit is also configured to receive input from the input device 1202, in this case the switch 1214. The master microcontroller unit is configured to manage the charging of the battery and includes PWM outputs for supplying the appropriate power to the fans.

In various implementations, the components of the controller 240 are divided between multiple circuit boards. For example, a main board may include a microcontroller, pressure sensor, a speaker, and various other components, such as a voltage regulator, several choke coils for preventing excessive current, an on/off controller, a battery charger, including the battery manager 1208 and charge circuitry. A second controller board may include user interface circuitry, such as a microcontroller, LEDS, a speaker, and a diagnostic port interface. It will be appreciated that these components are exemplary only and other configurations and components are contemplated.

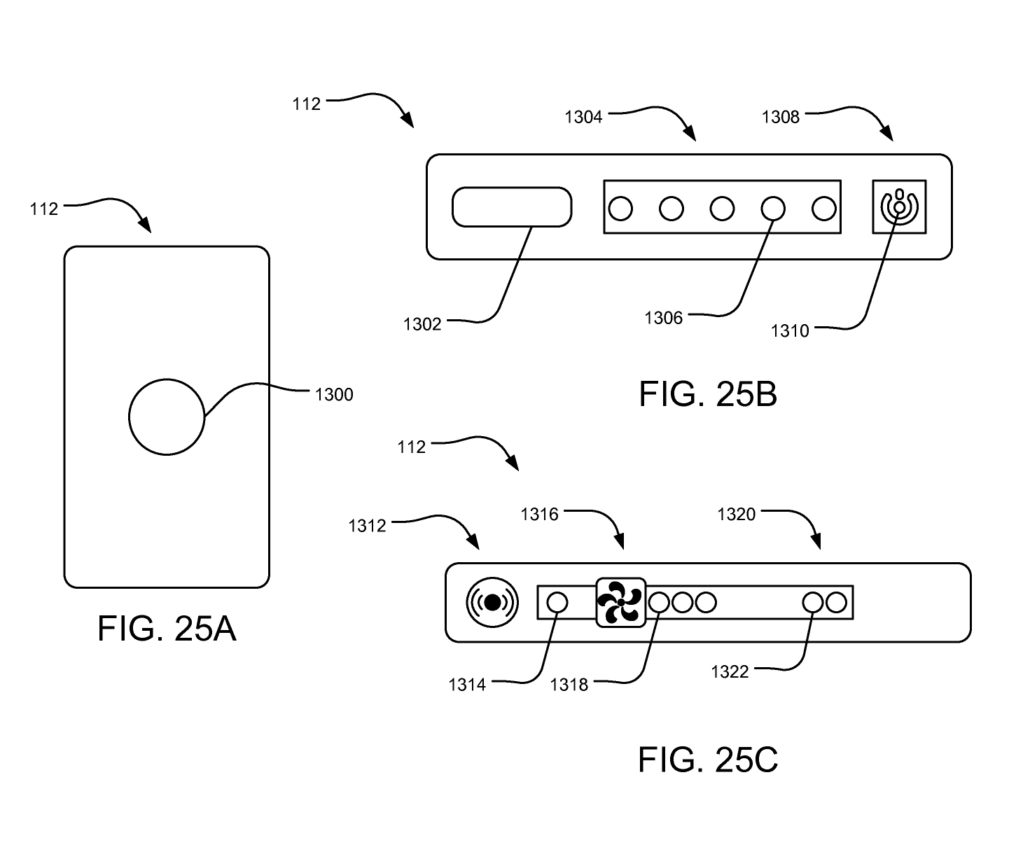

For a detailed description of the user device 112, reference is made to FIGS. 25A to 25C. In one implementation, the user device 112 includes a primary button 1300 facilitating control of the respirator 102. As described herein, the primary button 1300 may be used to activate the respirator 102, cycle though various fan speeds, and deactivate the respirator 102. Also as described herein, the user device 112 includes a connection 1302 for communicating with the controller 240. The connection 1302 may be a wired or wireless connection. The user device 1302 communicates with the controller 240 to provide various statuses regarding the operational parameters of the respirator 102. For example, the user device 112 may include: a power source indicator 1304 with one or more LEDs 1306 indicating the status of the power capacity; an on/off indicator 1308 with one or more LEDs 1310 being illuminated according to whether the respirator 102 is on or off; a low pressure alarm, which is activated using a pressure alarm button 1312 and indicated using one or more LEDs 1314; a fan speed indicator 1316 with one or more LEDs 1318 indicating the fan speed; and a filter status indicator 1320 with one or more LEDs 1322 indicating the status of whether the filters need replacing. Other visual, audible, and/or tactile feedback indicators are also contemplated. Moreover, the user device 112 may run an application for controlling, monitoring, and/or managing one or more respirators 102 and the corresponding data.

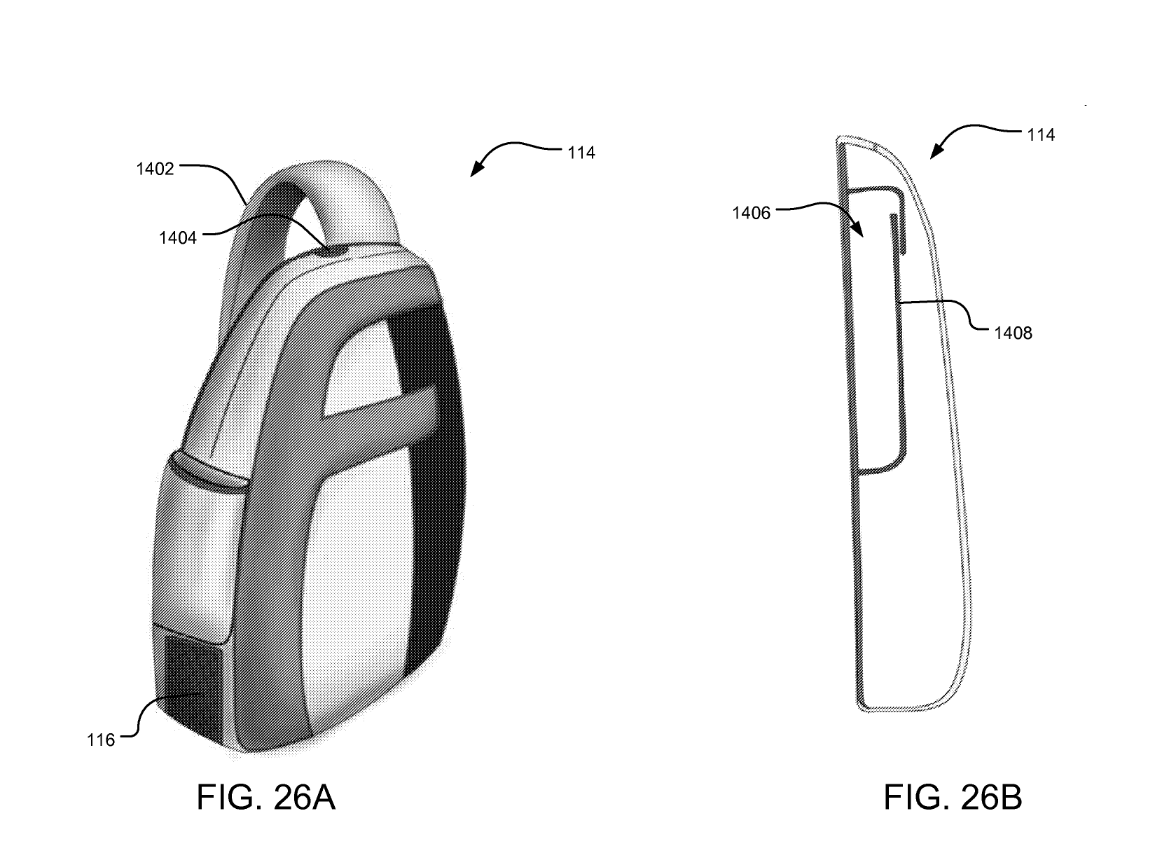

In certain implementations, the respirator 102 may be fitted into a carry case 114 including one or more carrying straps 1402 for ease of use, as shown in FIGS. 26A to 26B and described herein. The carrying case 114 may be configured as a messenger bag, briefcase, backpack, purse, fanny pack, suitcase, occupational or recreational bag, school bag, and the like In one implementation, the carrying case 114 includes one or more internal and external pockets. For example, the carrying case 114 may be configured with an internal pocket 1406 designed to accommodate the respirator 102. In another implementation, the carrying case 114 may be sized to more specifically accommodate the respirator 102, with one or more optional additional storage pockets. Further, the carrying case/backpack may be sized, shaped, and designed according to the physical characteristics and aesthetic preferences of the user.

As described herein, the hose 108 may run through the carrying strap 1402 of the carrying case 114 and extend through an opening 1404 into the inside of the carrying case 114 to connect with the respirator 102. The carrying case 114 may further include various pockets, venting openings 116, access panels, and the like.

In one implementation, the pocket 1406 is formed by a lining 1408 that comprises a sound and impact absorbing material to protect the respirator 102 and minimize any tactile or audial disturbance to the user that may be caused by the operation of the respirator 102. It will be appreciated that other areas of the carrying case 114 may alternatively or additional include such materials.

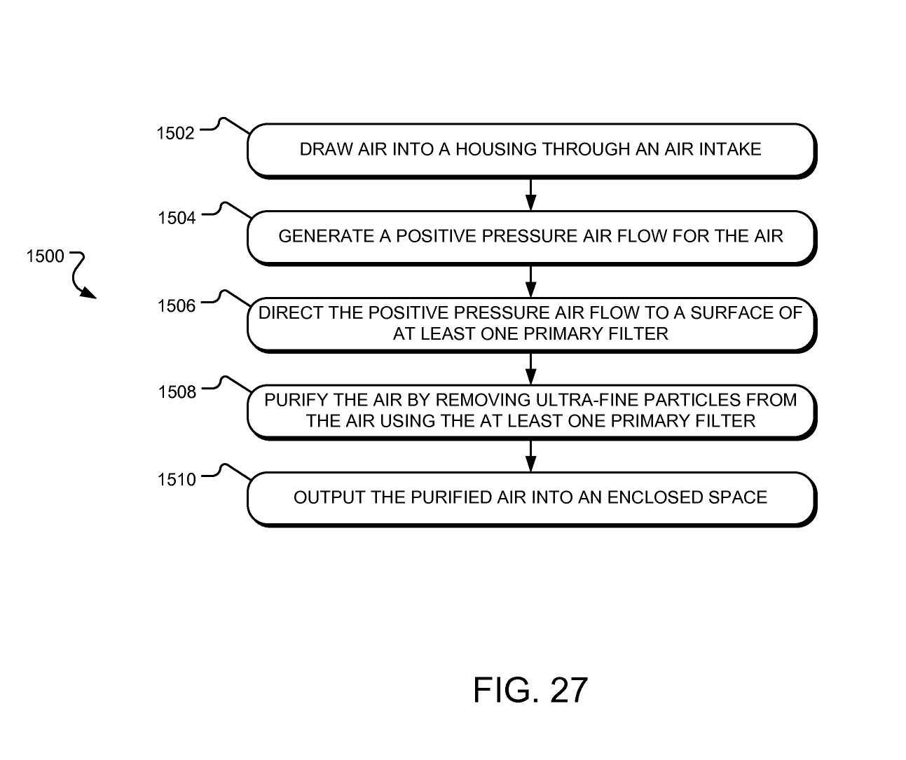

FIG. 27 illustrates example operations 1500 for purifying air. In one implementation, an operation 1502 draws air into a housing through an air intake. The air intake may comprise an air entry mesh. Alternatively, an air entry mesh may be disposed near the air intake and configured to remove large particulates. Further, large particles may be removed from the air using at least one pre-filter. In one implementation, the pre-filter is disposed downstream of at least one fan. In another implementation, the pre-filter is disposed upstream of at least one fan. The pre-filter may be made from a variety of materials, as described herein, including an activated carbon filter material.

In one implementation, an operation 1504 generates a positive pressure air flow for the air using at least one fan. The at least one fan may comprise a plurality of serially stacked, axial fans. In one implementation, the positive pressure air flow is generated at a hydrostatic pressure of at least 3 inches of water at an air flow rate between 50 standard liters per minute and 300 liters per minute.

An operation 1506 directs the positive pressure air flow to a surface of the at least one primary filter. In one implementation, the positive pressure air flow is directed to the surface of the at least one primary filter at a low face velocity of less than 5 cm/s.

An operation 1508 purifies the air by removing ultra-fine particles from the air using the at least one primary filter. The primary filter may be made from a variety of materials, as described herein, including a composite filter media. In one implementation, outgassing is removed from the air using at least one post-filter. The post-filter may be made from a variety of materials, as described herein, including an activated carbon filter material.

An operation 1510 outputs the purified air into an enclosed space, which may be, for example, a mask. In one implementation, the purified air is output through an outlet port, which may be disposed on an opposite wall of the housing as the air intake. The outlet port may include a back flow valve to prevent carbon dioxide buildup, among other benefits.

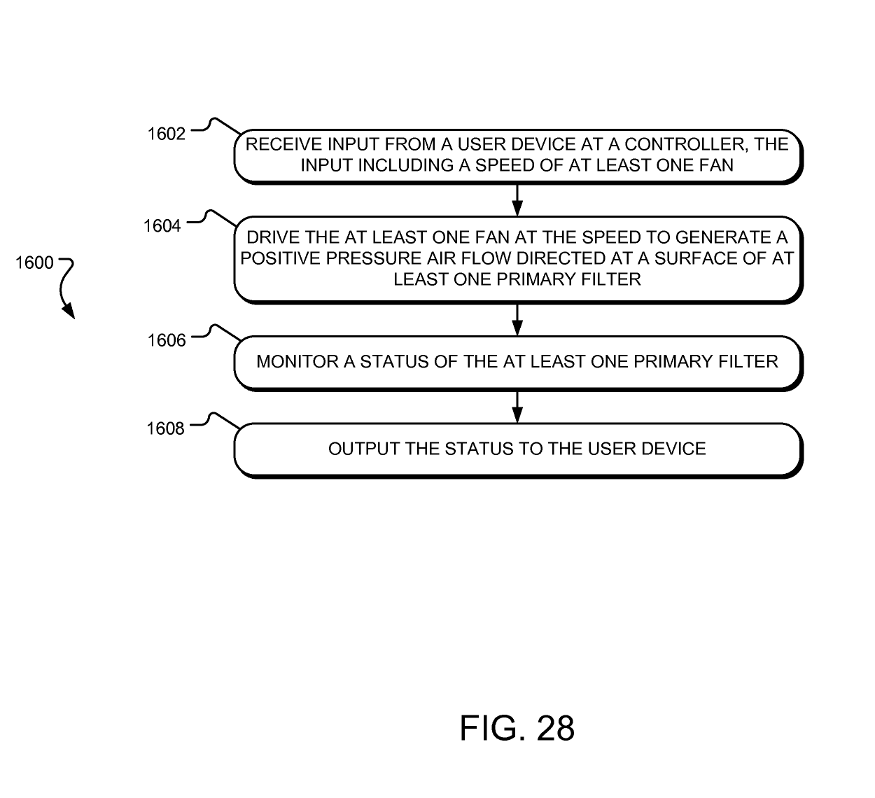

Turning to FIG. 28, example operations 1600 for controlling air filtration are shown. In one implementation, an operation 1602 receives input from a user device at a controller in electronic communication with at least one fan. The input may include a speed for that least one fan. The speed may be various speeds, including, without limitation, a low speed of 100 standard liters per minute, a medium speed of 130 standard liters per minute, and a high speed of 180 standard liters per minute. In one implementation, the at least one fan comprises a plurality of serially stacked, axial fans.

An operation 1604 drives the at least one fan at the speed to generate a positive pressure air flow directed at a surface of at least one primary filter configured for removing ultra-fine particles from the positive pressure air flow to produce purified air. In one implementation, the positive pressure air flow is directed to the surface of the at least one primary filter at a low face velocity, which may be less than 5 centimeters per second. The positive pressure air flow may be generated at a hydrostatic pressure of at least 3 inches of water and an air flow rate between 50 standard liters per minute and 300 standard liters per minute.

In one implementation, an operation 1606 monitors a status of the at least one primary filter, and an operations 1608 outputs the status to the user device.

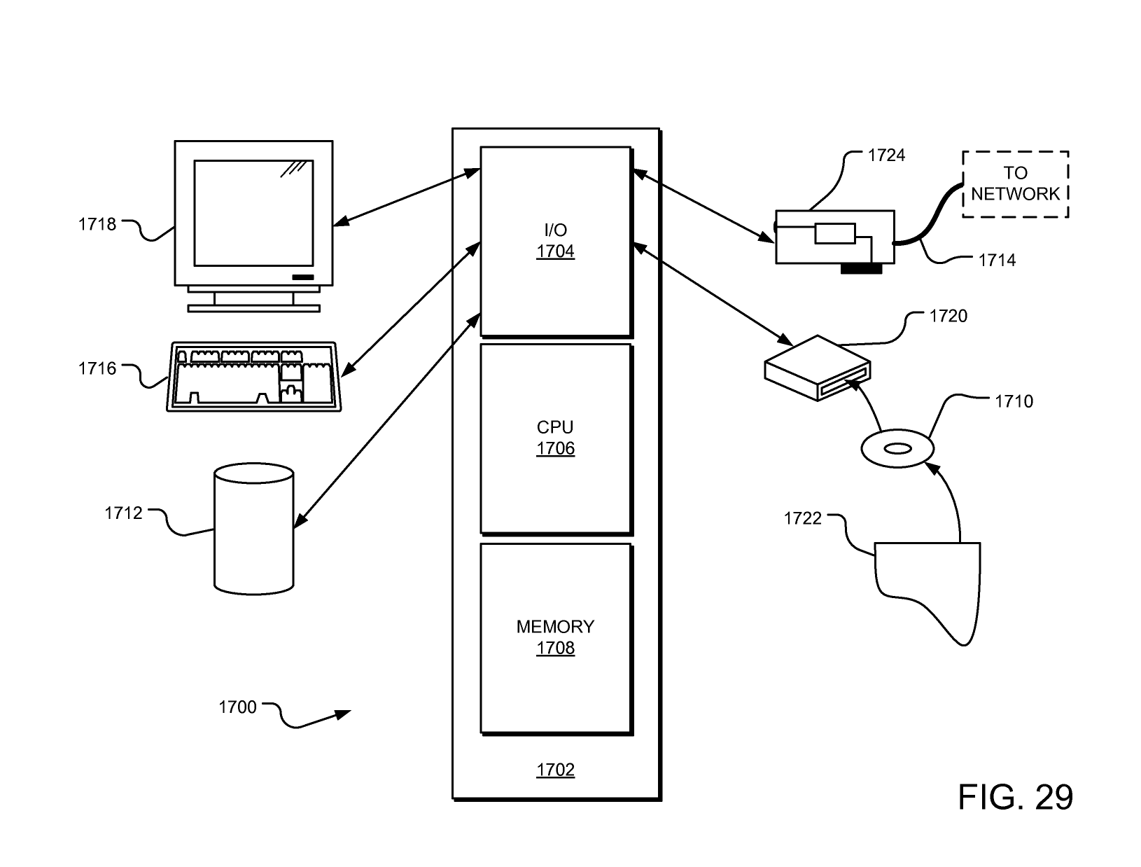

Referring to FIG. 29, a detailed description of an example computing system 1700 having one or more computing units that may implement various systems and methods discussed herein is provided. The computing system 1700 may be applicable to the user device 112, the respirator 102, or other computing devices. It will be appreciated that specific implementations of these devices may be of differing possible specific computing architectures not all of which are specifically discussed herein but will be understood by those of ordinary skill in the art.

The computer system 1700 may be a general computing system is capable of executing a computer program product to execute a computer process. Data and program files may be input to the computer system 1700, which reads the files and executes the programs therein. Some of the elements of a general purpose computer system 1700 are shown in FIG. 29 wherein a processor 1702 is shown having an input/output (I/O) section 1704, a Central Processing Unit (CPU) 1706, and memory 1708. There may be one or more processors 1702, such that the processor 1702 of the computer system 1700 comprises a single central-processing unit 1706, or a plurality of processing units, commonly referred to as a parallel processing environment. The computer system 1700 may be a conventional computer, a distributed computer, or any other type of computer, such as one or more external computers made available via a cloud computing or other network architecture. The presently described technology is optionally implemented in software devices loaded in memory 1708, stored on a configured DVD/CD-ROM 1710 or storage unit 1712, and/or communicated via a wired or wireless network link 1714, thereby transforming the computer system 1700 in FIG. 29 to a special purpose machine for implementing the described operations.

The I/O section 1704 is connected to one or more user-interface devices (e.g., a keyboard 1716 and a display unit 1718), the storage unit 1712, and/or a disc drive unit 1720. In the case of a tablet or smart phone device, there may not be a physical keyboard but rather a touch screen with a computer generated touch screen keyboard. Generally, the disc drive unit 1720 is a DVD/CD-ROM drive unit capable of reading the DVD/CD-ROM 1710, which typically contains programs and data 1722. Computer program products containing mechanisms to effectuate the systems and methods in accordance with the presently described technology may reside in the memory section 1704, on the disc storage unit 1712, on the DVD/CD-ROM 1710 of the computer system 1700, or on external storage devices with such computer program products, including one or more database management products, web server products, application server products, and/or other additional software components. Alternatively, the disc drive unit 1720 may be replaced or supplemented by an optical drive unit, a flash drive unit, magnetic drive unit, or other storage medium drive unit. Similarly, the disc drive unit 1720 may be replaced or supplemented with random access memory (RAM), magnetic memory, optical memory, and/or various other possible forms of semiconductor based memories commonly found in smart phones and tablets.

The network adapter 1724 is capable of connecting the computer system 1700 to a network via the network link 1714, through which the computer system can receive instructions and data and/or issue file system operation requests. Examples of such systems include personal computers, Intel or PowerPC-based computing systems, AMD-based computing systems and other systems running a Windows-based, a UNIX-based, or other operating system. It should be understood that computing systems may also embody devices such as terminals, workstations, mobile phones, tablets or slates, multimedia consoles, gaming consoles, set top boxes, etc.

When used in a LAN-networking environment, the computer system 1700 is connected (by wired connection or wirelessly) to a local network through the network interface or adapter 1724, which is one type of communications device. When used in a WAN-networking environment, the computer system 1700 typically includes a modem, a network adapter, or any other type of communications device for establishing communications over the wide area network. In a networked environment, program modules depicted relative to the computer system 1700 or portions thereof, may be stored in a remote memory storage device. It is appreciated that the network connections shown are examples of communications devices for and other means of establishing a communications link between the computers may be used.

In an example implementation, respirator control software and other modules and services may be embodied by instructions stored on such storage systems and executed by the processor 1702. Some or all of the operations described herein may be performed by the processor 1702. Further, local computing systems, remote data sources and/or services, and other associated logic represent firmware, hardware, and/or software configured to control respirator operation. Such services may be implemented using a general purpose computer and specialized software (such as a server executing service software), a special purpose computing system and specialized software (such as a mobile device or network appliance executing service software), or other computing configurations. In addition, one or more functionalities of the systems and methods disclosed herein may be generated by the processor 1702 and a user may interact with a Graphical User Interface (GUI) using one or more user-interface devices (e.g., the keyboard 1716, the display unit 1718, and the user devices 112) with some of the data in use directly coming from online sources and data stores. The system set forth in FIG. 29 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented. Some or all of the steps may be executed in parallel, or may be omitted or repeated.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A respirator for providing purified air into an enclosed space, the respirator comprising:
a housing having a top wall connected to a bottom wall with a pair of opposing side walls;
at least one fan configured to draw unfiltered air into the housing and generate a positive pressure air flow;
a primary filter module disposed within the housing, the primary filter module including at least one primary filter, the positive pressure air flow provided to a surface of the primary filter at a low face velocity, the at least one primary filter removing ultra-fine particles from the positive pressure air flow and outputting the purified air; and
an outlet port through the housing, the outlet port receiving the purified air from the primary filter module and directing the purified air to the enclosed space.

2. The respirator of claim 1, further comprising:
at least one pre-filter configured to remove large particles from the positive pressure air flow.

3.-5. (canceled)

6. The respirator of claim 1, wherein the at least one fan comprises a plurality of serially stacked, axial fans.

7. The respirator of claim 1, further comprising:
an air entry mesh configured to remove large particulates from the unfiltered air drawn into the housing.

8. (canceled)

9. The respirator of claim 1, wherein the at least one primary filter comprises a composite filter media.

10. The respirator of claim 1, further comprising:
one or more post-filters configured to remove outgassing.

11. The respirator of claim 1, wherein the outlet port includes a back flow valve.

12. (canceled)

13. The respirator of claim 1, further comprising:
a diffuser disposed downstream of the at least one fan and configured to spread the positive pressure air flow across the surface of the at least one primary filter.

14. (canceled)

15. The respirator of claim 1, further comprising:
a controller in electronic communication with a power source, the controller configured to provide power from the power source to drive the at least one fan.

16.-17. (canceled)

18. The respirator of claim 1, wherein the enclosed space is contained within a mask.

19. The respirator of claim 1, wherein the low face velocity is less than 5 centimeters per second.

20. A method for purifying air, the method comprising:
drawing air into a housing through an air intake;
generating a positive pressure air flow for the air using at least one fan;
directing the positive pressure air flow to a surface of at least one primary filter;
producing purified air by removing ultra-fine particles from the air using the at least one primary filter; and
outputting the purified air into an enclosed space.

21. The method of claim 20, wherein the positive pressure air flow is directed to the surface of the at least one primary filter at a low face velocity.

22. The method of claim 21, wherein the low face velocity is less than 5 centimeters per second.

23.-60. (canceled)

61. A system for filtering air, the system comprising:
a housing having an interior;
a plurality of serially stacked, axial fans configured to draw air into the interior of the housing and generate a positive pressure air flow;
a primary filter module disposed within the interior of the housing and including at least one primary filter for removing ultra-fine particles, the plurality of fans directing the positive pressure air flow through the at least one primary filter to provide purified air; and
an outlet port through the housing, the outlet port receiving the purified air from the primary filter module and directing the purified air to an enclosed space at the positive pressure air flow.

62. The system of claim 61, wherein the plurality of fans are disposed in a fan housing having an air inlet upstream of the plurality of fans and an air outlet downstream of the plurality of fans.

63. The system of claim 62, wherein a diffuser is disposed near the air outlet in the fan housing for spreading the positive pressure air flow across a surface of the at least one primary filter.

64. The system of claim 61, wherein the plurality of fans provide the positive pressure air flow at a surface of the at least one primary filter at a low face velocity.

65. The system of claim 64, wherein the low face velocity is less than 5 centimeters per second.

66. The system of claim 61, further comprising:
one or more pressure sensors for measuring the pressure along the positive pressure air flow.

67.-115. (canceled)
